(19) United States
(12) Patent Application Publication
(10) Pub. No.: US 2016/0344946 A1
(43) Pub. Date: Nov. 24, 2016

(54) Screen System

(71) Applicant: Peter Michalik, Liptovsky Hradok (SK)

(72) Inventor: Peter Michalik, Liptovsky Hradok (SK)

(21) Appl. No.: 15/161,199

(22) Filed: May 21, 2016

Related U.S. Application Data
(60) Provisional application No. 62/165,828, filed on May 22, 2015.

(51) Int. Cl. H04N 5/268; H04N 5/232; H04N 5/262; H04N 5/247; H04N 5/265

(52) U.S. Cl. CPC H04N 5/268; H04N 5/247; H04N 5/265; H04N 5/2624; H04N 5/23293; H04N 5/2628; H04N 5/23212

(57) ABSTRACT

At least one embodiment of the invention relates to a display screen comprising a first area comprising at least one status indicator and a plurality of different areas such as a preview window, an output window, an audio level indicator, at least one window having at least one video feed, a cut and transition control section, a plurality of buttons for switching sources and events, and at least one area for settings of the parameters wherein the display screen is configured to allow control over multiple feeds to a single screen which allows for the selection of different types of feeds from different cameras. In at least one embodiment there is a process for changing a display comprising the following steps setting a first video in a first preview screen; setting a second video in a second screen; moving said first video from said first preview screen to said second screen. In at least one embodiment, there is the step of pressing a button that activates a switching mode for switching videos between at least two different screens.

### CROSS REFERENCE TO RELATED APPLICATIONS

This application is a non provisional application that claims priority from U.S. Provisional Application Ser. No. 62/165,828 titled Display Screen System and Process for Displaying a Screen filed on May 22, 2015 the disclosure of which is hereby incorporated herein by reference.

### BACKGROUND

At least one embodiment of the invention relates to a display screen which has a plurality of different areas which allow for viewing of different video feeds. The screen also has a plurality of buttons which allow for the switching of one screen from one area to another area.

### SUMMARY

At least one embodiment of the invention relates to a display screen comprising a first area comprising at least one status indicator and a plurality of different areas such as a preview window, an output window, an audio level indicator, at least one window having at least one video feed, a cut and transition control section, a plurality of buttons for switching sources and events, and at least one area for settings of the parameters wherein the display screen is configured to allow control over multiple feeds to a single screen which allows for the selection of different types of feeds from different cameras.

In at least one embodiment, the display screen further comprises at least one of the following buttons: help, mute, audio, audio settings, autofocus, snapshot, current time, recording duration, and settings.

In at least one embodiment the preview window is positioned in a top left region of the screen.

In at least one embodiment, the output window is positioned in a top right of the display screen.

In at least one embodiment there is at least one button which is configured to transfer at least one video from said preview window to said output window.

In at least one embodiment there is a screen that has a plurality of buttons that comprise a matrix of buttons.

In at least one embodiment there are a plurality of settings area that are configured as a plurality of settings of parameters of particular functions, inputs, and effects.

In at least one embodiment there is a display that comprises a plurality of windows with videos from a plurality of different input devices.

In at least one embodiment there is a process for changing a display comprising the following steps setting a first video in a first preview screen; setting a second video in a second screen; moving said first video from said first preview screen to said second screen.

In at least one embodiment there is the step of pressing a button that activates a switching mode for switching videos between at least two different screens.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a first graphical representation of a video display screen;

FIG. 2 is a first view of a main window video screen;

FIG. 3 is a second view of a main window showing a selected button for transition settings;

FIG. 4 is a first flow chart of the process;

FIG. 5 is a second flow chart of the process;

FIG. 6 is a view of a smartphone screen;

FIG. 7 is a view of a bank setup layout;

FIG. 8 is a view of an output layout;

FIG. 9A is a view of a preview layout;

FIG. 9B is a view of a multi layout;

FIG. 9C is a view of a bank setup layout;

FIG. 9D is a view of a feed control layout;

FIG. 9E is a view of a large screen layout;

FIG. 9F is a view of another screen for a portable device;

FIG. 9G is a view of the screen of FIG. 9F being implemented;

FIG. 9H is a view of another screen;

FIG. 9I is a view of the screen of FIG. 9H being implemented;

FIG. 9J is a view of a another mobile screen;

FIG. 9K is a view of the screen of FIG. 9K being implemented;

FIG. 9L is a view of another screen;

FIG. 9M is a view of another screen;

FIG. 9N is a view of another screen;

FIG. 9O is a view of another screen;

FIG. 9P is a view of another screen;

FIG. 9Q is a view of another screen;

FIG. 10 is a view of a screen having a PTZ controller;

FIG. 11 is a schematic block diagram of the electronic components for controlling the video screen or the PTZ controller;

FIG. 12 is the flow chart for the process for controlling the PTZ controller;

FIG. 13 is a flow chart for changing patterns for recording;

FIG. 14 is a screen shot of a pattern for a proposed shaky cam; and

FIG. 15 is another flow chart for setting patterns with the shaky cam;

FIG. 16A is another embodiment which shows different tracking cameras used in the system;

FIG. 16B is an embodiment of a device for tracking subjects;

FIG. 16C is a schematic block diagram of an example of the controlling computer;

FIG. 16D is an embodiment of a PTZ system;

FIG. 17 is an example of a pattern put forth by the tracking cameras;

FIG. 18 is an example of a user being tracked using the device shown in FIG. 16B;

FIG. 19 is an example of a screenshot of a user who is being tracked by a camera wherein the user has a tracking device;

FIG. 20 is an example of a screen shot of a user being tracked;

FIG. 21 is an example of a screen shot of a user being tracked;

FIG. 22 is an example of a user being tracked;

FIG. 23 is an example of tracking lines for tracking a user; and

FIG. 24 is a flow chart showing the process for tracking a user.

### DETAILED DESCRIPTION

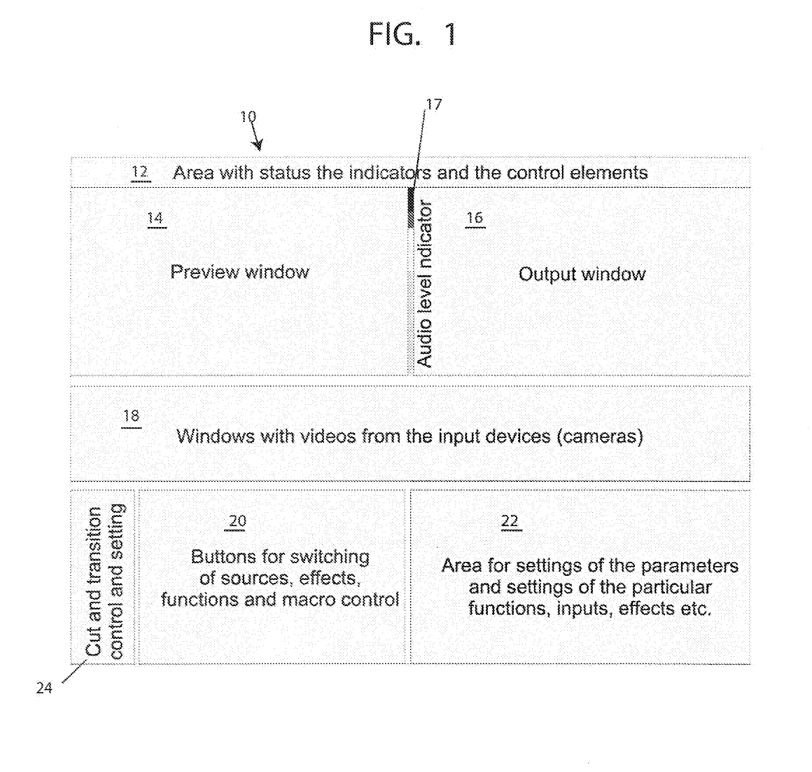

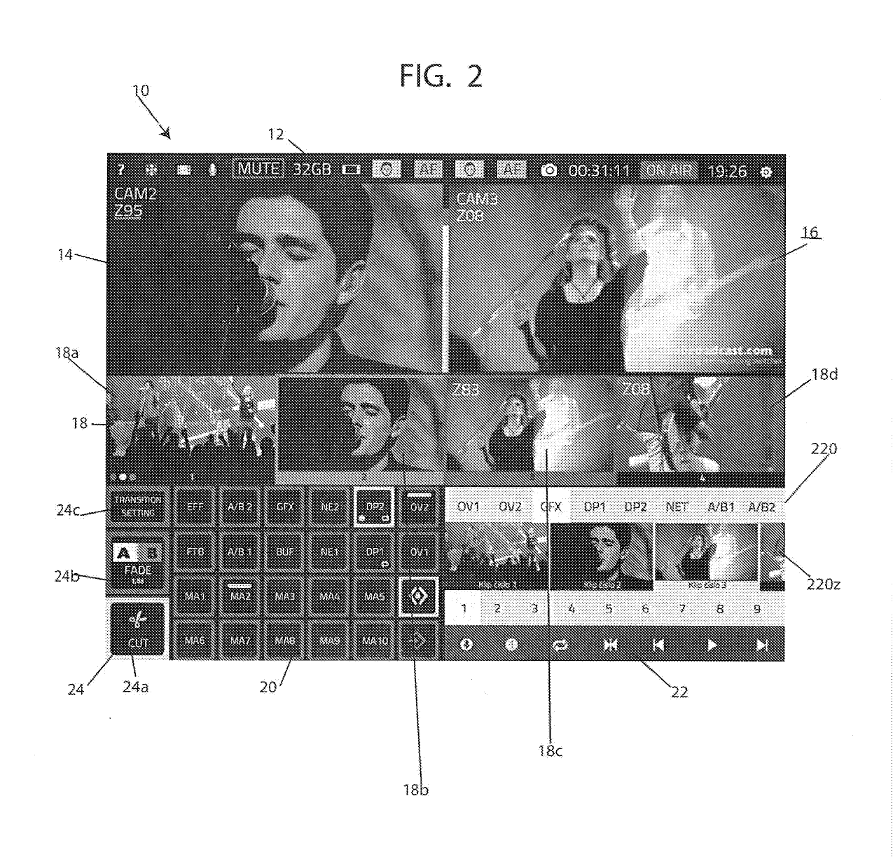

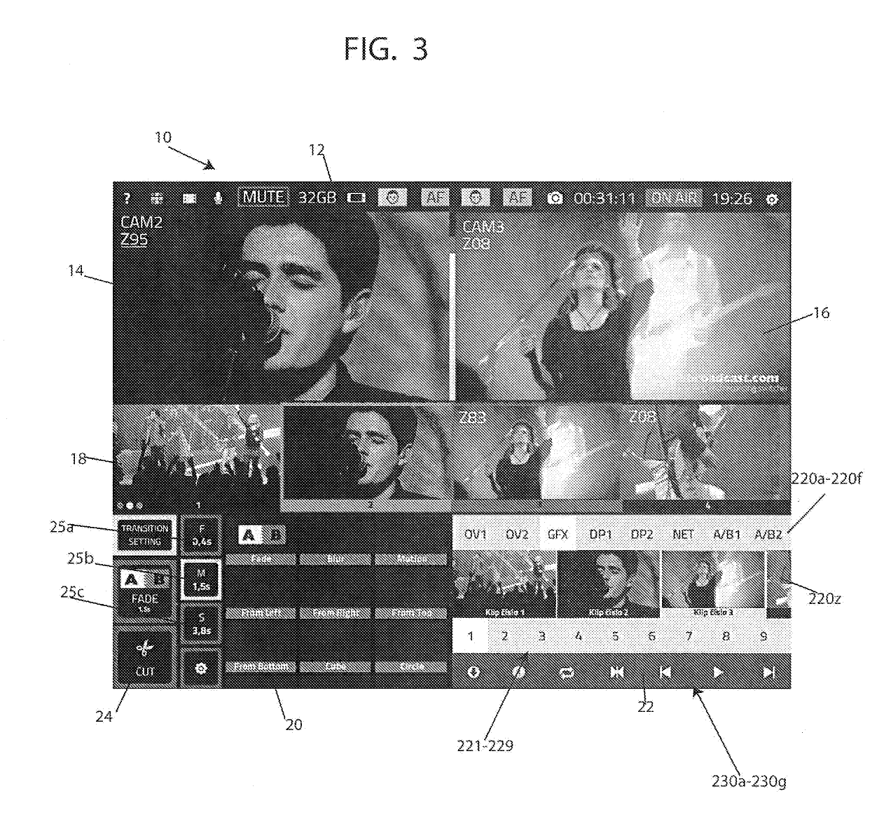

FIG. 1 is a first graphical representation of a simplified video display screen. This screen 10 includes at least the following two areas: a first area comprising at least one status indicator 12 and a preview window 14. There is also an output window 16, and an audio level indicator 17, disposed between windows 14 and 16. There is an array of windows 18 disposed below the preview window and above the buttons. This array is for the different camera inputs. There is a cut and transition control section 24 which includes the following buttons, the cut button 24a, (See FIG. 2) the transition button 24b, and the transition setting button 24c (See also FIGS. 2 and 3). There are also a plurality of buttons 20 for switching sources and events, at least one area for settings of the parameters 22 wherein the display screen is configured to allow control over multiple feeds to a single screen which allows for the selection of different types of feeds from different cameras. These different areas allow for the display of different feeds of video information to a single screen. Under these two windows are four camera inputs 18a, 18b, 18c, and 18d (See FIG. 2) showing video from other smartphones/tablets connected on the same wifi network.

The output or preview window 14 is triggered immediately to extend over to the output window by pressing “CUT” button 24a or with any other animated transition by pressing transition button 24c. The type of the transition setting button 24c can be chosen using above button “TRANSITION SETTING” 24c. With this button, it is possible to choose type of the transition, duration and other transition settings. As shown in FIG. 3 there are three buttons 25a, 25b, and 25c each with the predefined duration which value can be changed by longer pressing of that particular button.

First, a user can choose the duration of the video, and after choosing what the effect will be, this area is automatically switched back to previous mode with all buttons visible. It is an advantage because the “cut” button 24a is the dedicated button. Thus it is most used type of transition. Settings of the other transition effects is provided by a trigger button such as 24b and another button nearby 24c which will set desired type of the transition for the trigger button. The selected name of type of the transition will be displayed on the trigger button 24b. There can be displayed the visual representation of selected transition. This is an advantage because it saves a display space.

The buttons area 20 is the matrix of the buttons which will display content of the particular button in the preview area. When a particular button is activated, it means that each pressed button will be shown directly in the output window. This pressed button is called a “hot” button. When this feature is activated, all actions will perform immediately in the output recording and in the live stream too.

Because the buttons can be activated selectively in the buttons window, this allows for the conservative use of space so that a plurality of different buttons can be selectively activated and brought forth without having to display all of the buttons all at once. For example, in the button area there are present keys which trigger the recorded macros. In larger buttons it is an advantage when is displaying the picture representing the actual selected function like on the transition button.

Beside this button area is the “settings area” 22. In this area are presented all available functions with detailed settings of the content and parameters of the particular function.

In the setting area, there is a top bar 220 (FIGS. 2 and 3) with functions such as overlays 220a (shown as OV1 and Ov2), network inputs 220b (GFX), graphics 220c (DP1, DP2), digital players 220d (NET), camera inputs 220e, combined channels etc 220f (A/B1, A/B2). Below is available content for this function with preview thumbnail shown in section 220z which shows multiple different windows for showing this section. Below this section are nine buttons 221-229 (numbered 1-9) with store banks where there can be stored nine different sets of content for the particular function. On the bottom is displayed the bar 230 with control buttons 230a, 230b, 230c, 230d, 230e, 230f, 230g, for this particular function. The content of this bottom button area will accommodate according the selected function. When the button with the lock is activated, then it will join the actions of the button area and the settings area together. It means that when one function is selected on one side, then it is automatically is selected on the other side too and displayed in the preview window. This is an advantage because in some situations, it is very useful to immediately see all of the settings of the selected function. If a “hot” button activated it will be displayed directly in the output window.

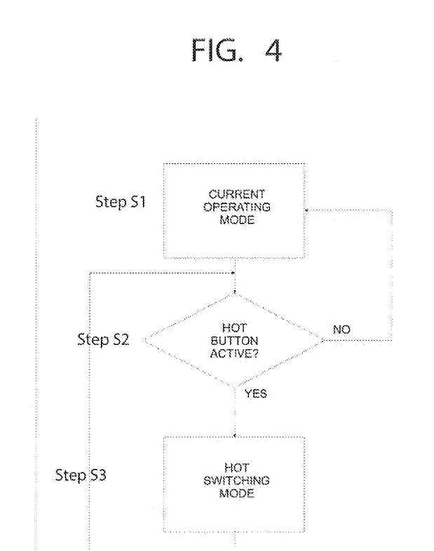

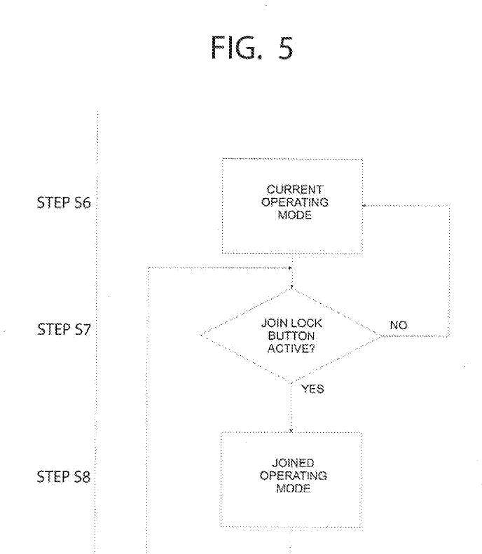

FIGS. 4 and 5 show flow charts for the use of these screens. For example, as shown in FIG. 4, in these flow charts there is step S1 wherein the screen operates in a current operating mode. Next, the system which controls the screen determines whether the hot button is active in step S2. If the hot button is not active, then the system proceeds back to the current operating mode. Alternatively, if the system determines that the hot button is active, then the system proceeds to the hot switching mode. With the hot switching mode, the screen is activated so that it can be changed or modified to suit the user's tastes. Alternatively, the system can proceed back to step 1 when the user decides to deactivate the hot button mode. Then the system proceeds back to step S1 wherein the screen operates back in a current operating mode.

Next, in FIG. 5 there is another flow chart wherein in step S6 the system operates in a current operating mode. Next, in step S7 the system determines whether the join look button is active. Next if the system determines whether the join look button is active, then the system proceeds to step S8 wherein it determines that it has joined operating mode. If alternatively the joint button is determined to be not active, then the system can proceed back to a current operating mode wherein the system can then wait until it is determined that the joint lock button is active again.

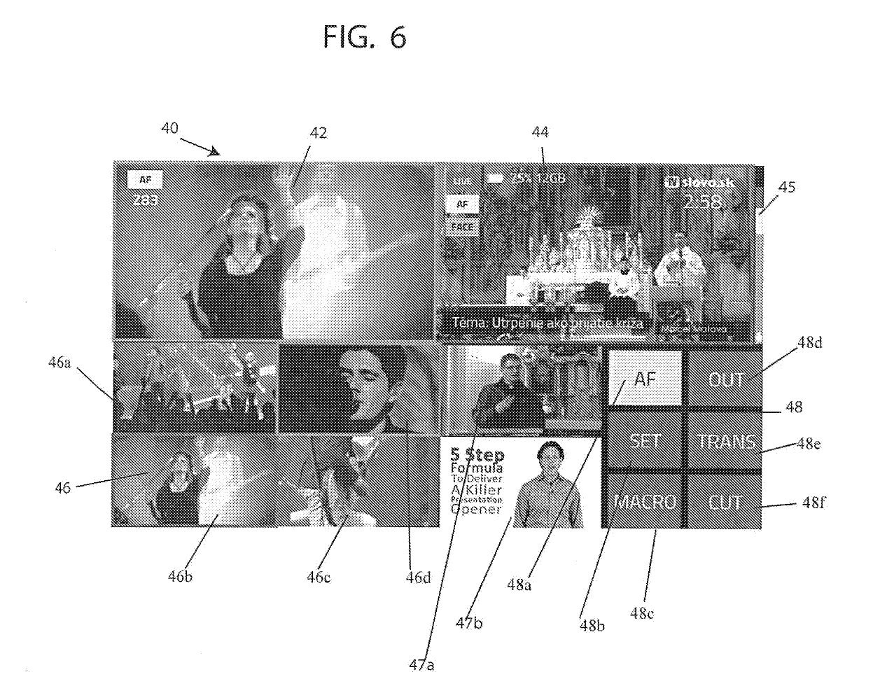

As shown in FIG. 6 there is a “multi layout” screen. On the top left side is preview window 42. Next to it is the output window 44 and beside of it is output volume indicator 45. Under of the preview window are four screens 46a, 46b, 46c, and 46c with four camera pictures. On the right side of this four camera windows there are two previews of the banks 47a, and 47b. In these two banks 47a and 47b can be selected any of the available functions e.g. digital players, graphics, network inputs or mixed channels.

In the bottom right corner of the display there are buttons 48a, 48b, 48c, 48d, 48e and 48f. These buttons are autofocus 48a, set 48b, macro 48c, out 48d, trans button 48e and cut 48f. The advantage is that when is the button “SET” pressed, then this will change the functionality of the present buttons. The set function will remain to deactivate this mode. After the “set” 48b button is pressed there can be these new function available on the same buttons e.g. general settings, mute, hot, transition settings. The banks will be changed to set mode too to allow set the desired function in the particular bank. Even camera areas can be switched to the set mode. This solution is an advantage because with this is achieved high efficiency of available displaying space and all elements are in biggest possible dimensions.

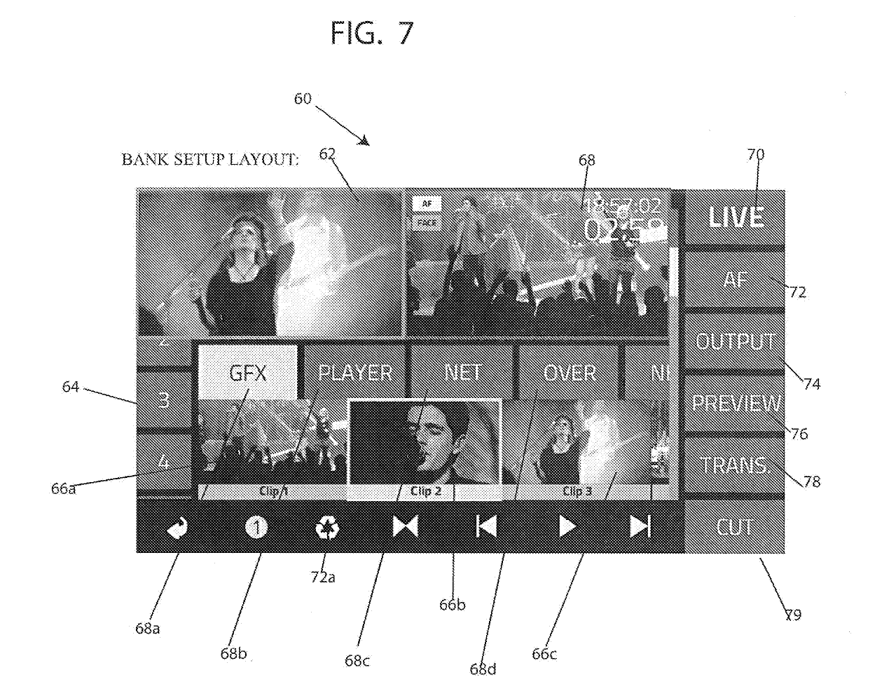

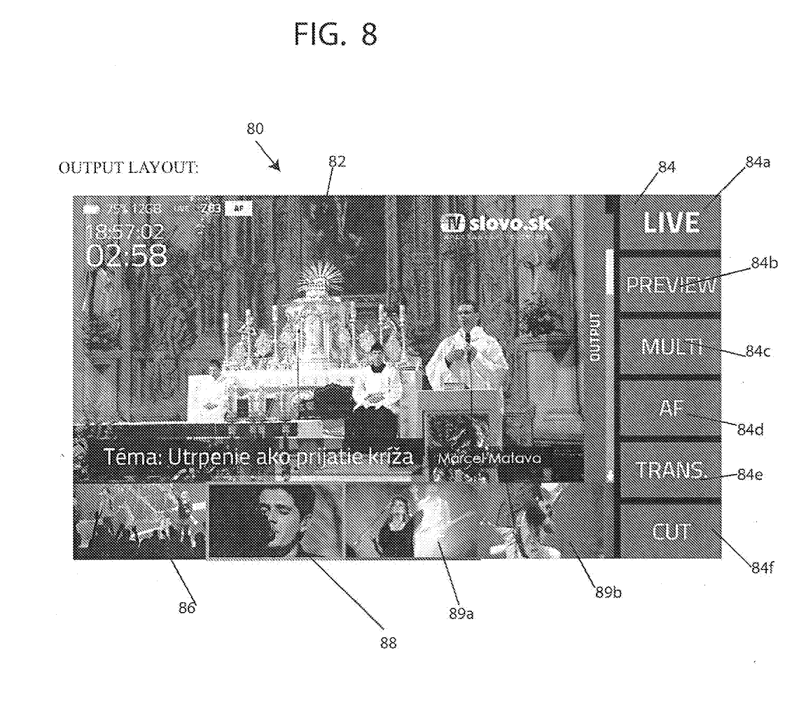

FIG. 7 shows the bank setup layout while FIG. 8 shows the output layout of the type of screen shown in FIG. 6.

For example in FIG. 7 there is shown a first input screen 62, an output screen 68, and a series of buttons positioned below these screens including buttons 68a, 68b, 68c, 68d, which align with the GFX button 68a, the player button 68b, the net button 68c, the over button 68d. In addition, there are other screens including screens 66a, 66b, and 66c which provide different clips to be shown to users. Furthermore, there are additional buttons including a live button 70, an AF button 72, an output button 74, a preview button 76, a transition button 78, and a cut button 79. There is also a loop button 72a which allows the program to be re-looped.

FIG. 8 shows the output layout screen which shows a first screen 82, and a button field 84 including a series of buttons 84a, 84b, 84c, 84d 84e, and 84f. These buttons include a live button 84a, a preview button 84b, a multi button 84c, an AF button 84d, a transition button 84e, and a cut button 84f. In addition there are additional feeds 86, 88, 89a, and 89b providing separate feedable sections which can be selected for viewing in section or first screen 82.

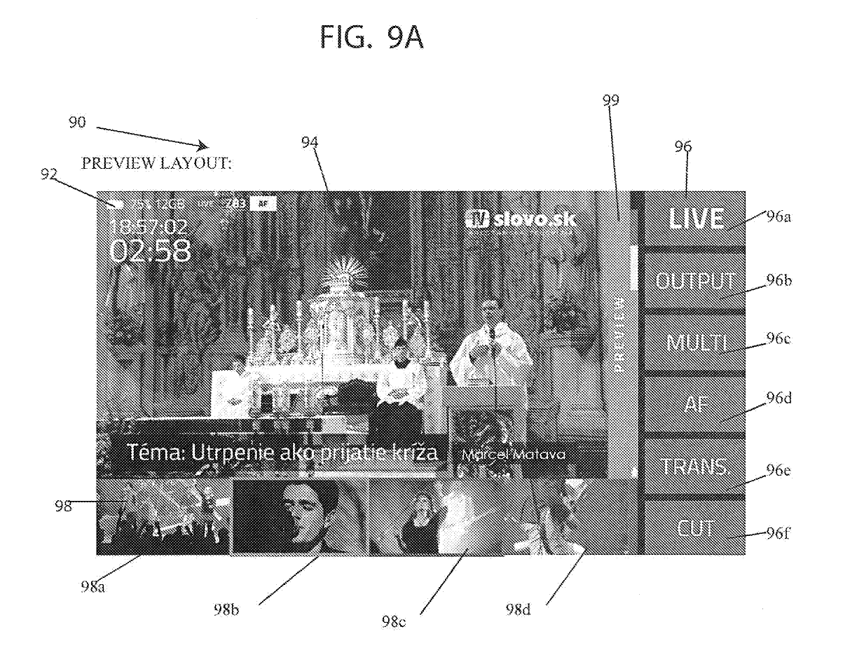

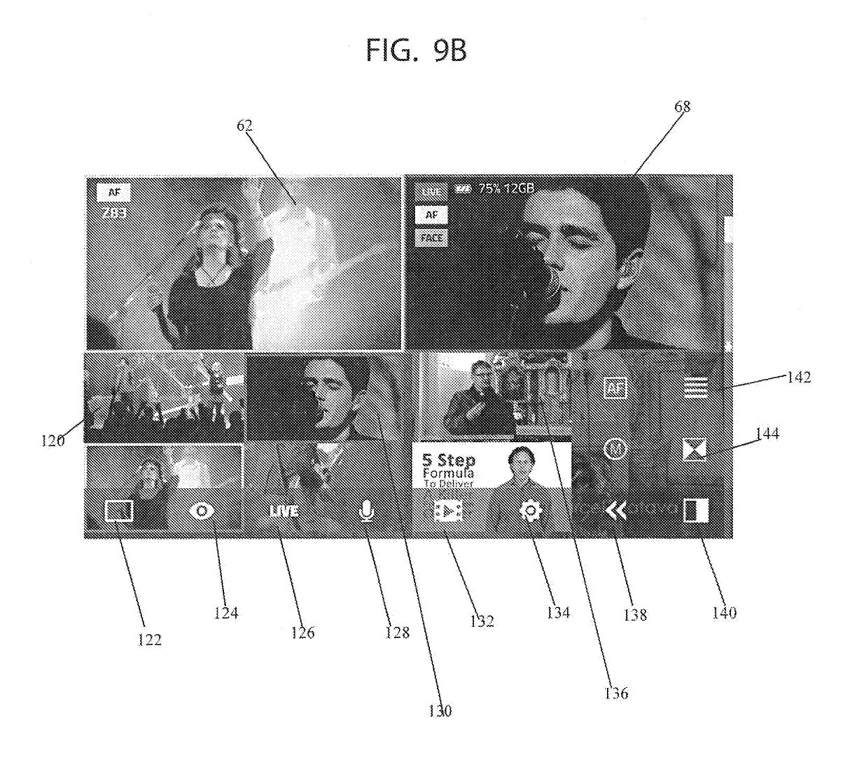

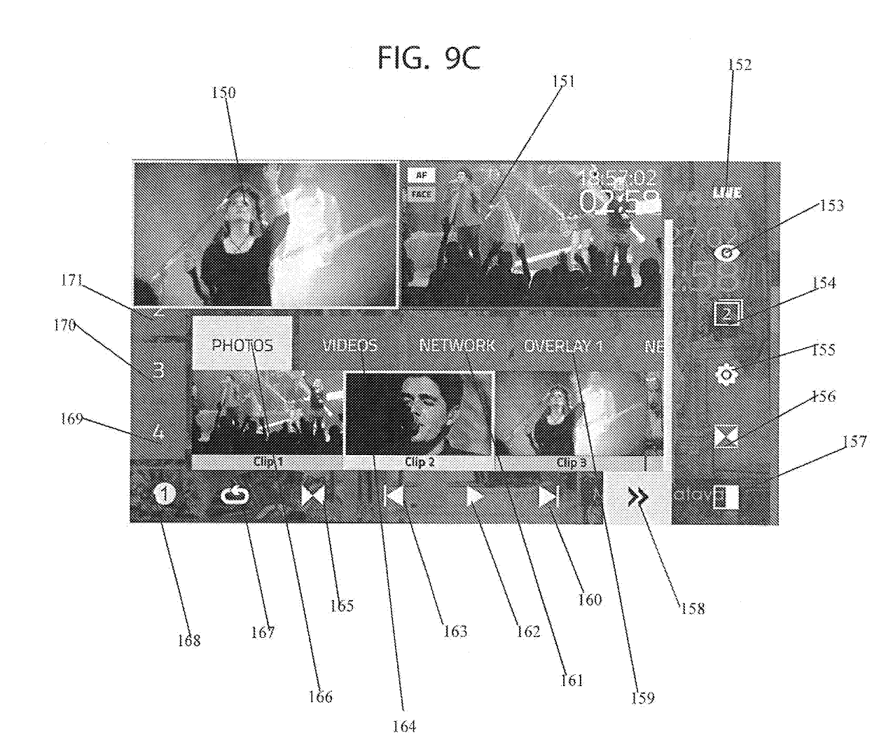

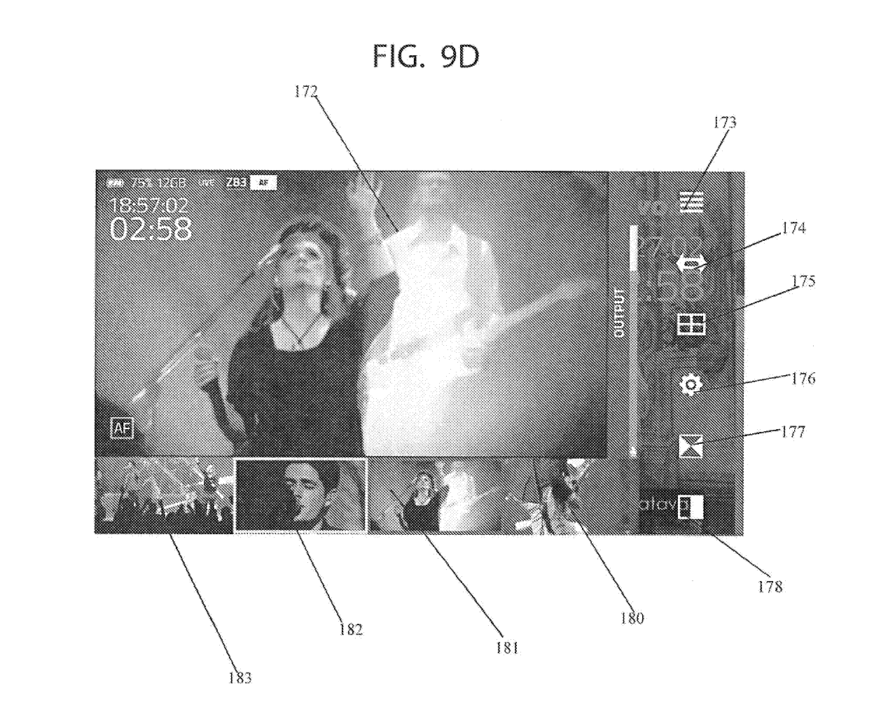

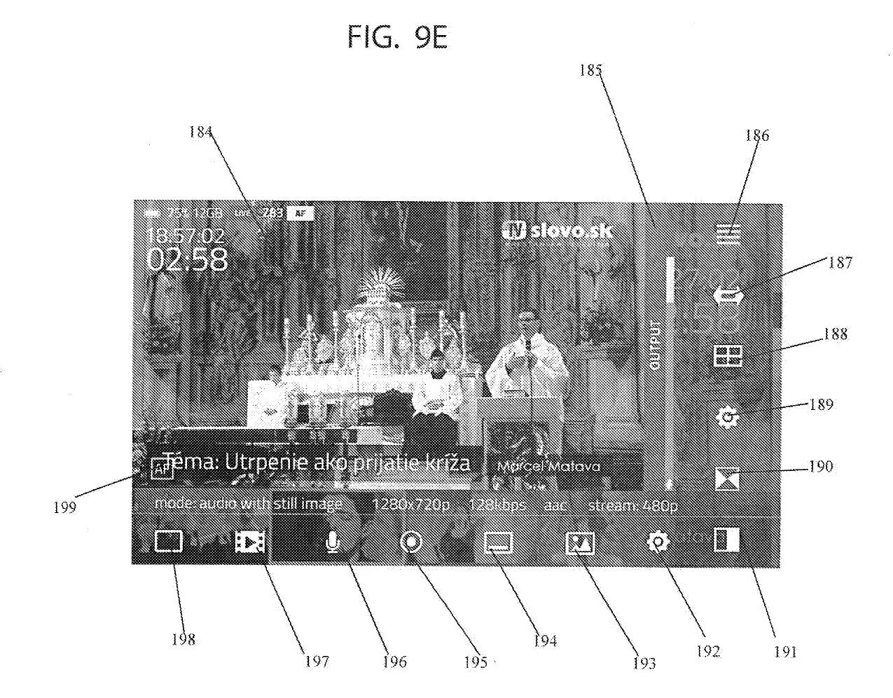

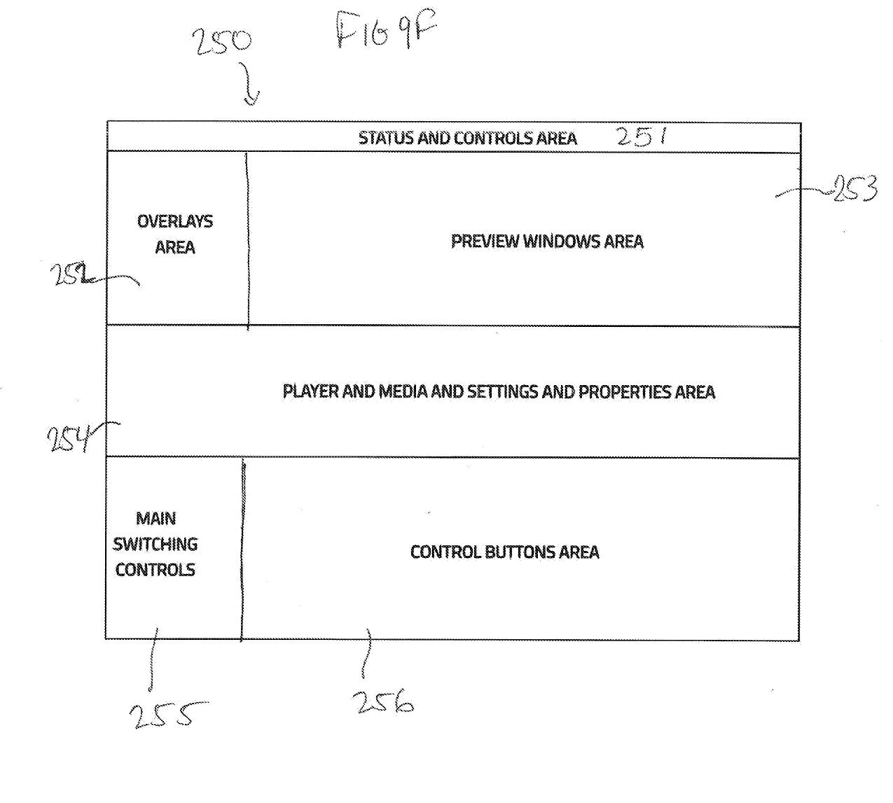

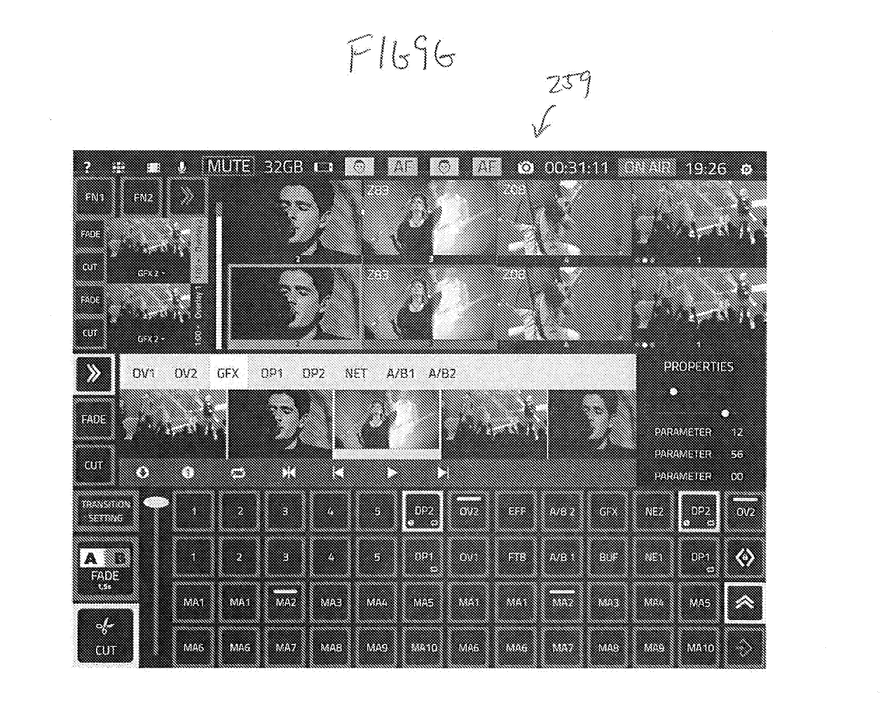

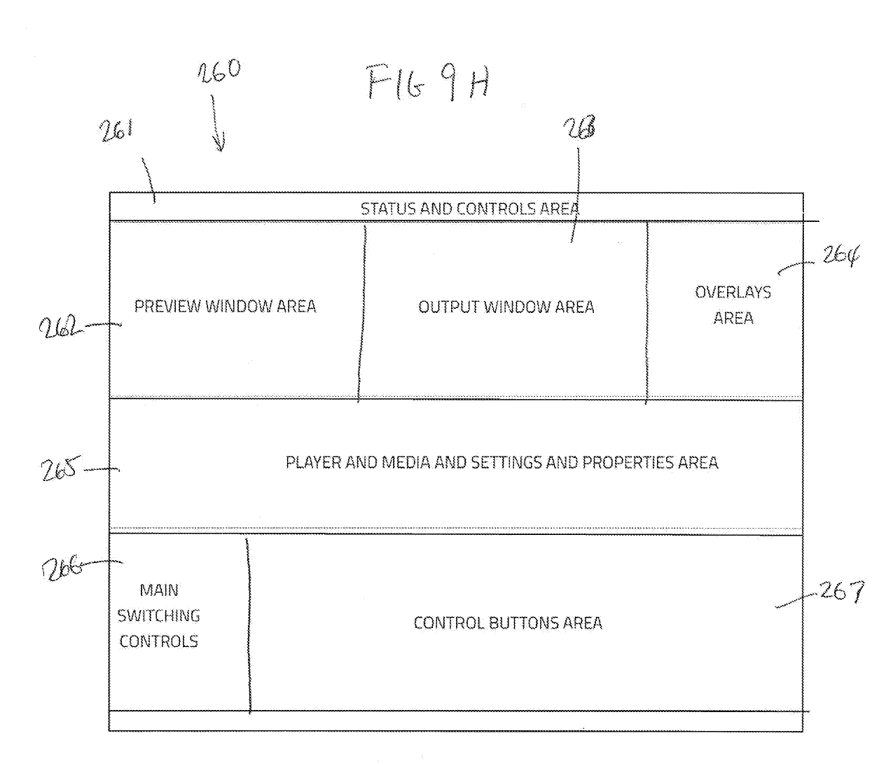

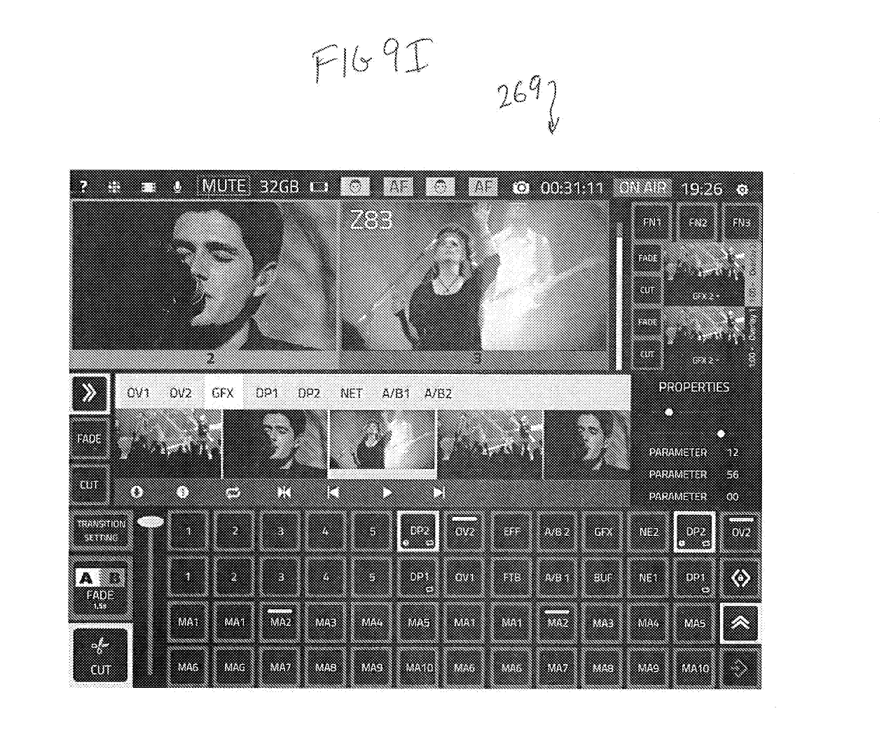

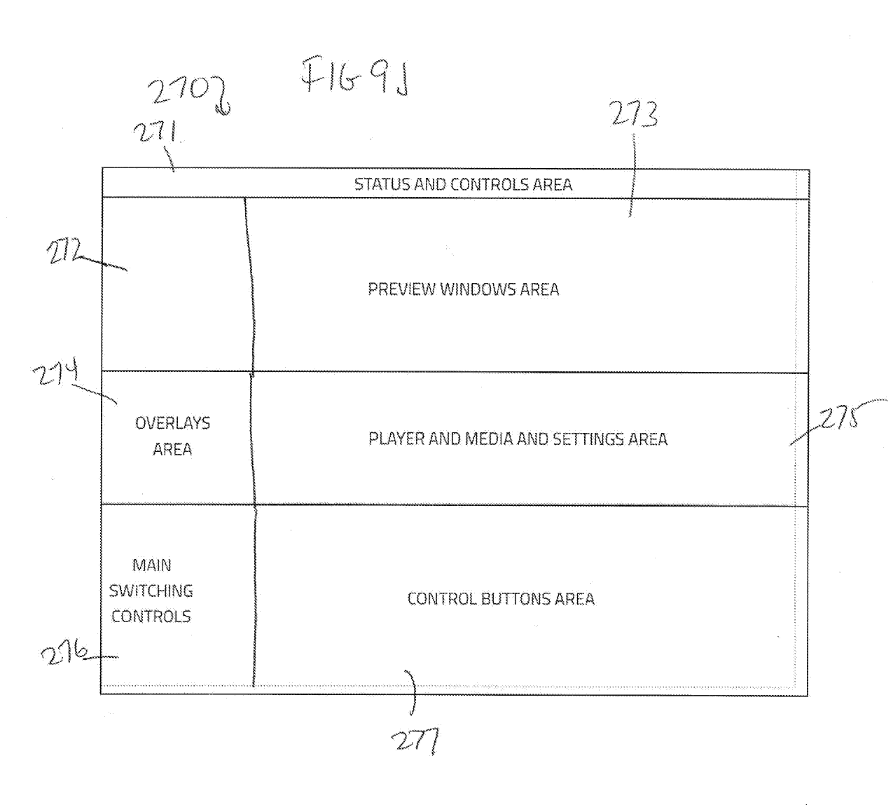

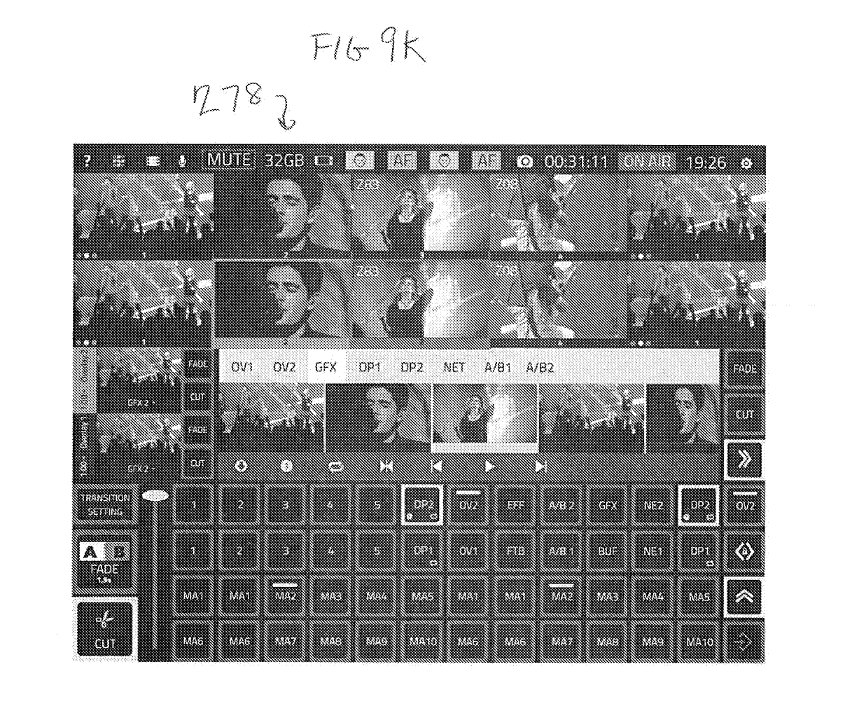

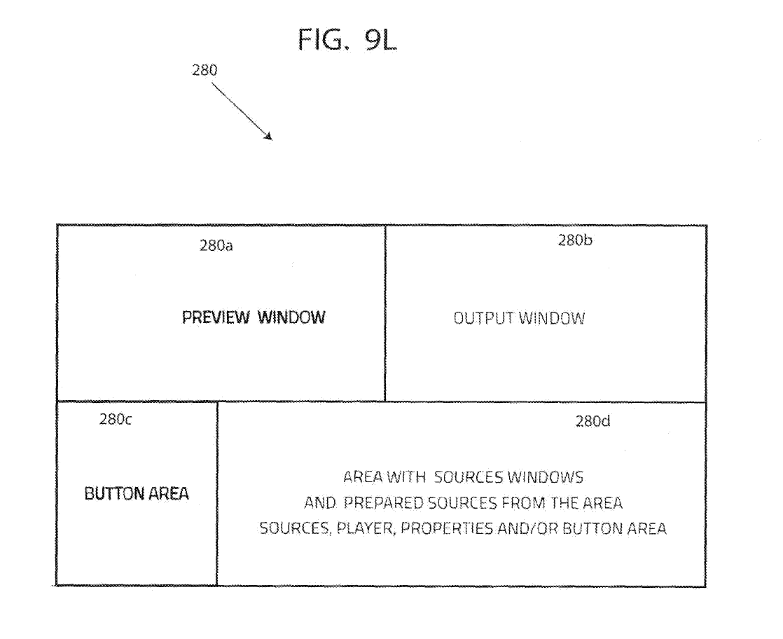

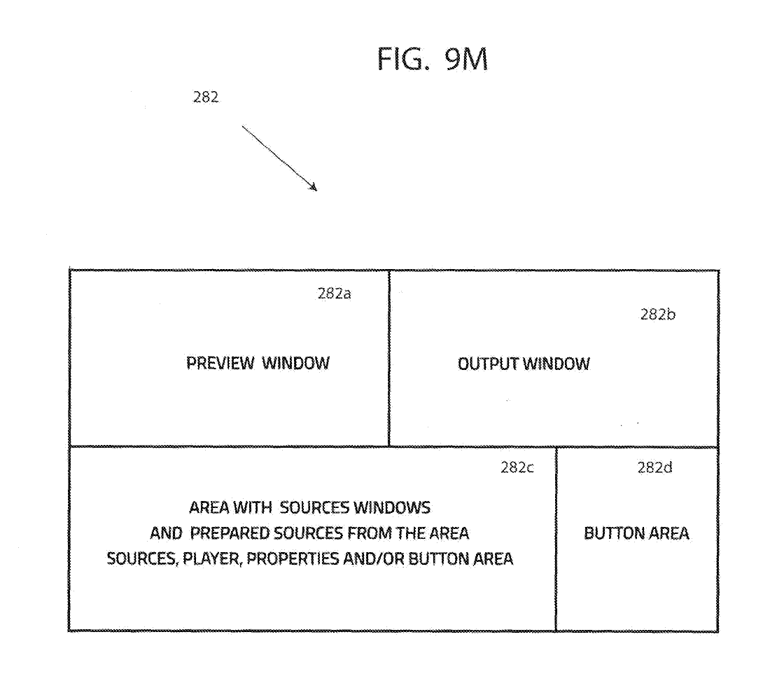

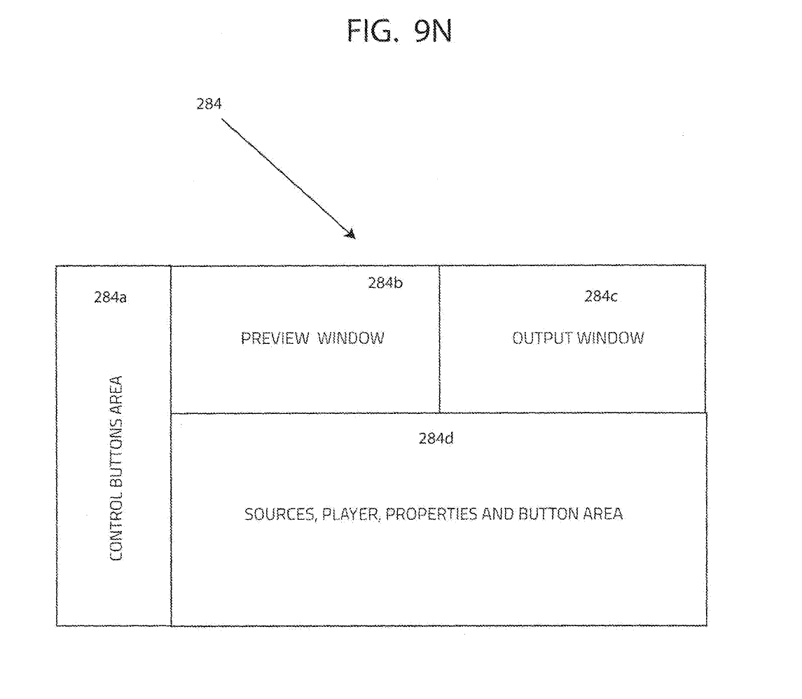

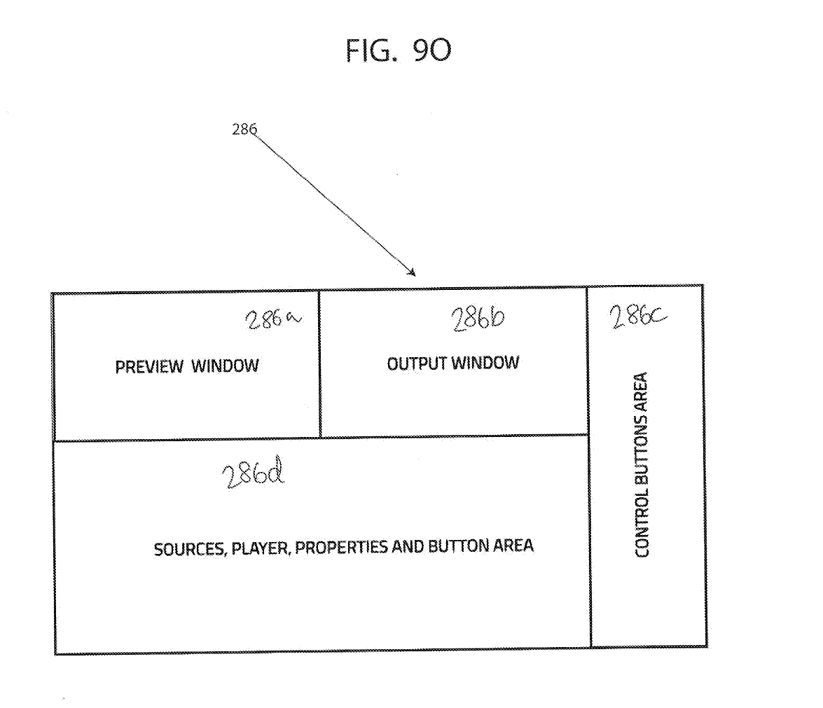

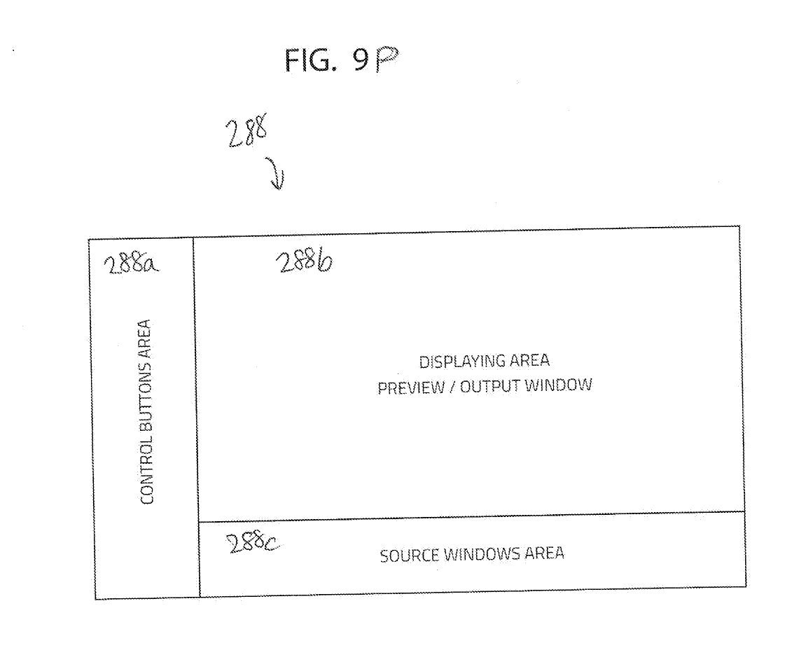

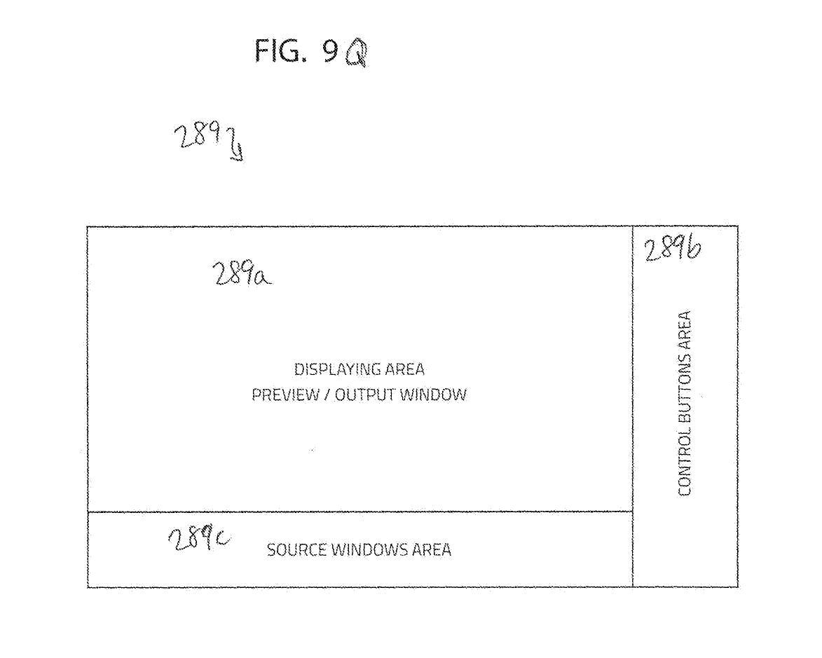

In addition, FIG. 9A shows the preview layout screen 90 wherein when the button “OUT” is pressed in the multi layout, then the output layout will be displayed. On the top left, is big output window or main screen 92. On the bottom, are pictures of available cameras in region 98. On the right side are control buttons 96. These control buttons 96a-96f are similar to the control buttons shown in FIG. 8. This layout is an advantage because the displaying space is very well used with four preview screens 98a, 98b, 98c, and 98d extending along a bottom section. Any one of these sections can be selected for use with the main screen 92 in the preview layout. With the control buttons 96 positioned along the right hand side of the screen and identifying information positioned in the top left corner, this provides a convenient screen for viewing and editing.

For example, when the button “Preview” 99 is pressed then it will be switched to “Preview layout”. This layout is almost identical with “Output layout” shown in FIG. 8 but there is big preview window on the top left. Those three displaying modes can be switched only with two buttons because one layout is selected and rest of the two layouts are available on the buttons for immediate use. This switching of the buttons is a big advantage because in every moment is every layout directly accessible with only two buttons.

FIG. 9B is another screen which shows input screens 62 and 64 as indicated above. There are buttons 122, 124, 126, 128, 132, 134, 138 disposed along the bottom of the screen. There are also screens 120, 130 and 136 disposed in a middle region on the screen as well. In addition, there is a button 142, a button 144, and a button 140 disposed along the side of the screen. For example button 122 is for full screen mode, button 124 is for preview mode, button 126 is for live output, button 128 is for audio settings, screen 130 is a selection screen, button 132 is a recorded clips button, button 134 is a settings button, button 138 is a show settings button, and button 140 is a cut, instant change button. Button 144 is a fade or transition button, button 142 is a show bottom menu for 15 seconds (or preset period of time button). The different smaller screens such as the screens 120, 136 etc, and 130 are screens which are used to preview so the user can switch between the screens.

FIG. 9C shows the different screens with different menu options. The screens include a first screen 150 and a second screen 151. There is a live button 152, a show preview button 153, a switch bank button 154, which allows the user to switch between different screens, a various settings button 155, and a transition button 156. A cut button 157 is also present. In addition, there is an array of additional buttons and areas on the screen. For example, there is shown a numbered region having different options for feeds such as a first option 169, a second option 170 and a third option 171 for viewing screens. There is also a button 168 which allows the user to see these numbered options. In addition, there are also buttons for allowing viewing in different categories such as on for loop feeds 167, a button 165 for pausing play, a button for full rewind 163, a button for full fast forward 160, and a button for play 162. There is also a fast-forward button 158 as well. This screen also has buttons which allow the user to move between photos 166, videos 164, network 161, and overlay 159. his screen can then for a bank set up layout which allows for a bank of different video feeds to be fed to the screen.

FIG. 9D is an output viewing screen which shows a plurality of different screens such as screen 172. There is a show bottom menu button 173, a switch between preview and live windows button 174, a show multi view layout 175, a show various settings button 176, a transition button 177, and a cut button 178 to cut portions of the video.

Another view 9E shows a screen 184 as well as an output tab 185, along with a series of buttons such as 186 which is the show bottom menu button 186, the switch between preview and live windows button 187, a show multi window button 188, a show various settings button 189, and a transition button 190. A cut button 191 is also shown along the right hand side towards the bottom of the screen.

The buttons at the bottom are the bottom menu buttons which includes fullscreen button 198, a play reel button 197, an audio settings button 196, a record button 195, a partial screen button 194, a video settings button 193, and a general settings button 192. This screen can be useful because it provides a large screen for viewing for a user while still allowing the user to control the settings of the feed and the video presentation.

All of the setups can be mirrored in vertical as well in horizontal axis to better accommodate to the users needs e.g. left-handed users. Such layouts of the elements are an advantage because the space is well used even on the small displays like tablets and smartphones.

In another embodiment, there is a system for controlling camera movement. In this embodiment there is an application that would control the pan/tilt or pan/tilt/zoom devices called in the text simply PTZ. In that app user can define multiple “key” points. The system is configured to control the exact position of the ptz device and exact scale of the zoom.

FIG. 9F is a view of a screen 250 for a mobile device. In this view there are a plurality different areas which are used for different buttons. For example, there is a status and control area 251. The status and controls area shows the status for the screen while indicating different conditions such as whether the sound is muted, whether there is battery power left, how much time is playing in a recording etc. There is also, an overlays area, which allows for at least two video screens to be shown. There is a previews windows area 253, allows for multiple different windows to be previewed to be shown. There is a player and media and settings and properties area 254 which allows the user to switch between different visual screens using different options. There is also a main switching controls area 255 which allows the user to fade in and out of different screens, and a control buttons area 256 which allows the user to select different inputs for the screens.

An example of this screen being implemented is shown in FIG. 9G with screen 259.

Next, in FIG. 9H there is another screen 260 which can be used for a mobile screen. This screen has a plurality of different sections or areas including a status and controls area 261, a preview windows area 262, an output windows area 263, an overlays area 264, a player and media and settings and properties area 265 a main switching area 266 and a control buttons area 267. All the areas named in this screen are the same or similar to the areas named in the screen for FIG. 9F. However the output windows area 263 is an enlarged window which shows an output of a video.

FIG. 9I shows the output of the screen 269 from FIG. 9H.

FIG. 9J shows another screen 270 which shows a plurality of different areas including a status and control area 271, a preview windows area 273, an overlays area 274, an player and media and settings area 275, main switching controls area 276 and a control buttons area 277.

FIG. 9K shows an implementation of these features for an example.

FIG. 9L is a view of another screen 280 which shows a preview window 280a, an output window 280b for outputting the video image disposed adjacent and to the right of the preview window. There is a button area 280c which is a virtual button area and which is disposed below the preview window and another area 280d disposed below the output window. This window is an area with source windows and prepared sources

FIG. 9M is a view of another screen. This screen includes at least one preview window 282a, an output window for the video 282b, an area with sources windows 282c, and a button area 282d wherein the button area is to control the other windows. This button area can be a virtual button area wherein the buttons can be created on a screen.

FIG. 9N is a view of another screen, which includes a plurality of different windows having a window 284a which is a control buttons area, wherein the control buttons can be either actual or virtual buttons. In this screen there is a preview area 284b, an output area for outputting videos 284c, and a sources player, properties and button area 284d.

FIG. 9O discloses another screen 286 with windows having a preview window 286a, for previewing videos, an output window 286b, a control buttons area 286c, and a sources player, properties and button area 286d.

FIG. 9P is a view of another screen. In this view there is a screen 286 which discloses windows including a preview window 286a, an output window 286b, an control buttons area 286c, and a sources, player properties and button area 286d.

FIG. 9Q is a view of another screen 289 which includes a window 289a which is a displaying area preview or output window. There is also a control buttons area 289b which can include actual physical buttons or virtual buttons. In addition, there is also a there is a source windows area 289c.

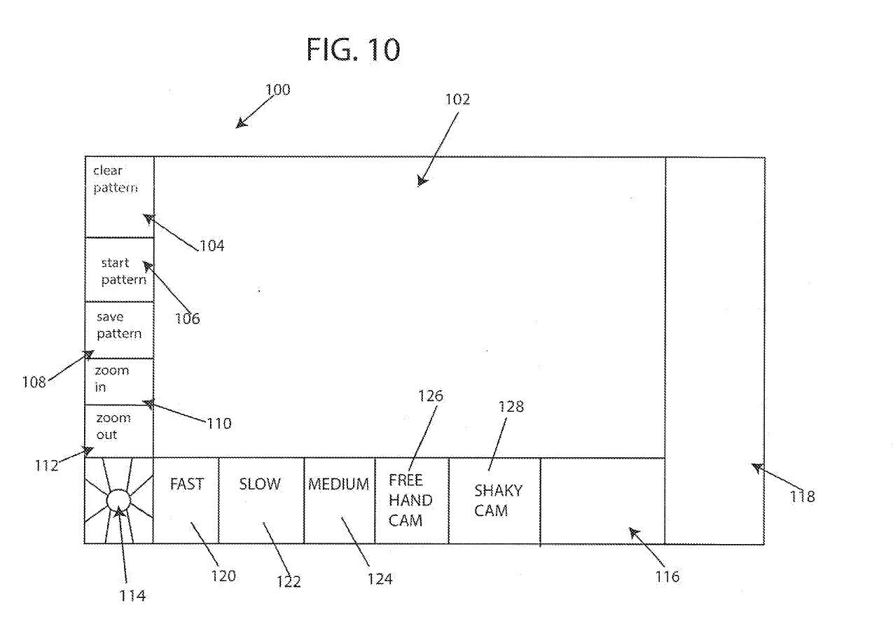

As shown in FIG. 10 there is a control screen 100 that will send that key points to the PTZ device and the device will compute movements among these points. Alternatively, the control application will control remote PTZ devices directly. For example, there is a screen 100 which shows the video camera in section 102. In addition, there are a plurality of sections providing buttons such as a clear pattern button 104, a start pattern button 106, a save pattern button 108, a zoom in button 110, a zoom out button 112. In addition, with control button 114 it is possible to create a trajectory which will be computed with even continuous adjusting of the zoom between these key points. The movement could be linear or smooth, following the path of the b-spline or bezier curve computed from the movement with these key points. Acceleration and deceleration of the movement of the PTZ device on the end points can be linear or following “S” curve to be perfect smooth. By pressing of the “FAST” button 120 in the particular direction will cause movement of the PTZ device in much higher speed in order to achieve quicker camera positioning. It can operate in two modes. Either quick movement is proceed only during the particular button is hold down or just press and release will cause quick repositioning to another key point or to the end point. There are also other buttons such as a slow button 122 or a medium button 124 which will set the movement speed of the cameras in their PTZ patterns.

Another feature is “free hand cam” as shown in button 126 or “shaky cam” shown in button 128. This new feature will simulate small camera movements placed in a PTZ device so the captured motion picture is not absolutely still without any movement, but it is moved like it would be held in hand of the human—little bit “shaky” with small random movements. It will cause the captured picture to be viewed as not so “sterile” but as more natural. This is achieved by the computing of the movement trajectory. The trajectory is represented by the final curve computed from points or segments which are generated or computed in the particular area. This area could be e.g. a simple rectangle and the points (segments) could be generated randomly or by any other mathematical function. In at least one embodiment, the movement pattern could be created or written by hand wherein the user could trace or record a “macro” wherein the movements of the camera are recorded based upon the movements of the user using the PTZ control. This movement pattern would be recreated using components such as a lens movement device, a gyroscope and or gimbals.

While this system can be used in conjunction with the system disclosed above for displaying video, this system, with the random control of the PTZ camera could also be used in a stand-alone PTZ system.

Dimensions of the area have affect to the amplitude of the final camera movement. The final output path of the PTZ device could be any suitable mathematical function. Best result path is generated by using of the B-spline or Bezier function. Speed of the movements of the PTZ device could be constant or variable. Computed variable speed will produce more realistic output. This feature can be as well part of the standalone or controlled pat/tilt and pan/tilt/zoom systems.

Both the screens shown in the drawings and described in the associated FIGS., and the process for controlling the cameras can be controlled by at least one electronic device such as a computer 200. The computer comprises at least one motherboard 210, which is configured to house a plurality of components. Coupled to the motherboard is at least one microprocessor 201. In addition, coupled to the motherboard is at least one memory 202. Memory 202 comprises RAM memory which is configured to act as a buffer feeding information into microprocessor 201 so that microprocessor 201 can perform a series of instructions. In addition, a mass storage (hard drive or ROM) device 203 is coupled to motherboard 210 and is configured to feed information into memory 202 upon the command of microprocessor 201. There is also a power supply 204 which is coupled to the motherboard 210 which is configured to provide power to the motherboard and to the components coupled to the motherboard. In addition, there is an input/output port 205 which is configured to allow for the input of information into the system. This information can be fed into the memory or RAM 202 which is then fed into the processor as at least one set of instructions. In addition, a transceiver 206 is coupled to motherboard 210. Transceiver 206 is configured to receive information from other electronic devices such as other computers. This information can then be sent on to memory 202, and if necessary then stored in the mass storage device 203. A video processor or video card 207 is coupled to motherboard 210. This video processor is configured to translate any information stored in the computer into video images on a video screen. An additional video processor 208 is coupled to the motherboard so that if the processing power of the first video processor 207 is insufficient, this additional video processor is available as well. In addition there is also an additional microprocessor 209 which can handle additional requests that cannot be handled by microprocessor 201.

Thus when commands are entered into the computer to control the video display such as that which is shown in FIGS. 1-3 and 6-9, or 12-15 these commands are then processed by the computer device 200.

In addition, this computer device can also be used also for controlling the movement of cameras either with the video system described above or separate from this video system.

For example, this system or computer device 200 can be used to set patterns for the movement of cameras such as set a pre-set pattern for movement of the cameras. This pre-set movement can be in the form of a “shaky cam” as described above, or in the form of any type of suitable camera motion.

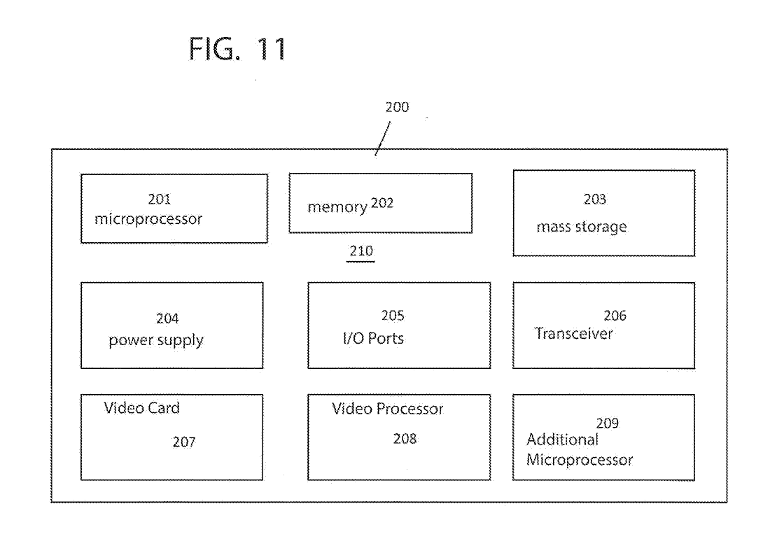

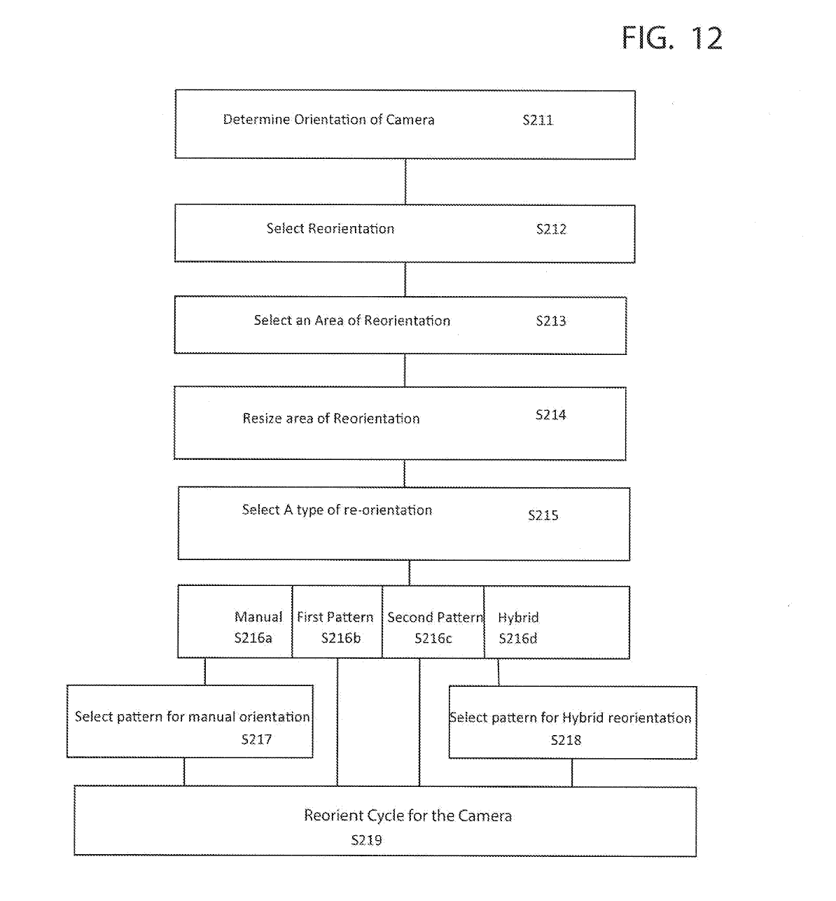

This process is shown in greater detail in FIG. 12. FIG. 12 shows the process for pre-programming a camera for particular movements. This process starts in step S211 wherein the system determines the orientation of a camera. Next, in step S212 the system can then determine the new orientation or that the camera should be reoriented. Next, in step S213 the system sets an area of reorientation. This area of reorientation is the area for movement of a camera once the system authorized its reorientation. Next in step S214 the system allows for this area of reorientation to be re-sized to a new area for movement of a camera. This re-sizing of the area can be performed either manually via a user or automatically via the system. Next, the user or the system can then select the type of reorientation that should occur. This type of re-orientation can be in the form of manual reorientation in step S216a, a first pre-set pattern of re-orientation in step S216b, a second pre-set pattern of re-orientation in step S216c or a hybrid set of re-orientation in steep S216d.

If the user has selected that the camera should be moved manually in step S216a, then the system proceeds to step S217 wherein the user then selects the pattern for the manual orientation. In this step, the user could control the camera using the various ptz buttons shown in greater detail in FIG. 10.

Alternatively, if the user selected a hybrid reorientation in step S216d, then this type of re-orientation would be a mix of both manual re-orientation and pre-set computer generated orientation. Thus, in step S218, the user could modify a pre-set computer pattern with manual manipulation using the ptz controller elements to create an entirely new pattern.

Once the patterns have been fixed, the system in step S219 can then run the reorientation cycle to cycle through a plurality of movements for a camera. These movements can be in the form of panning across a room, or even creating a “shaky camera” as described above.

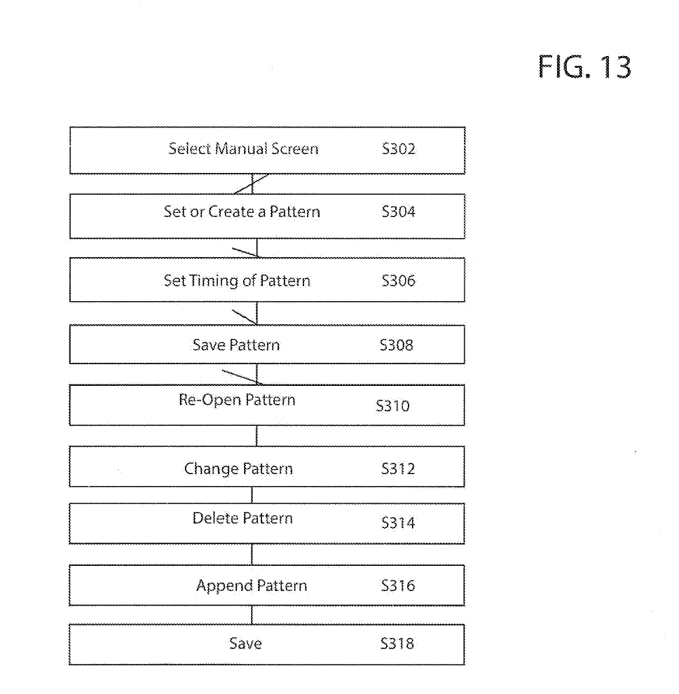

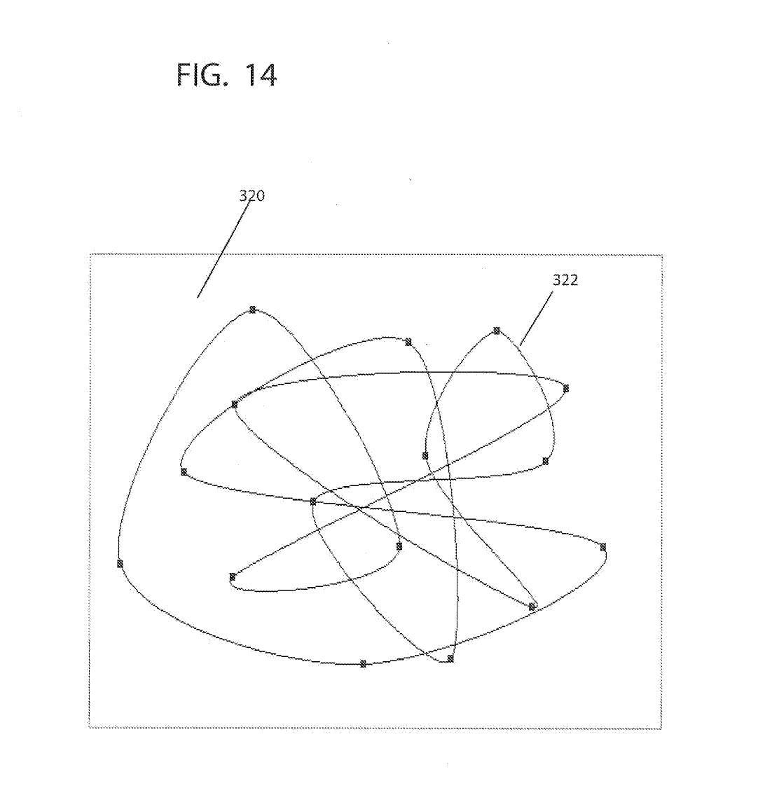

FIG. 13 is a flow chart for setting the manual pattern for the PTZ pattern for showing a “shaky” camera pattern. For example, the pattern starts with step S302 wherein the user can select a manual screen. Next, in step S304 the user can set or create a pattern. The setting of this patter can be done either manually using the button 114, or via a computer in step S305. Whether this pattern is set manually or via a computer an example of this pattern can be such as the camera pattern 322 shown in FIG. 14. Next in step S306 the user can set the timing pattern for the pattern of movement of the camera. The timing pattern can determine how fast or slow the movements that are possible with the camera. Next, in step S308 the user can save the pattern for both the movements and the timing of the pattern. Next, in step S310 the user can re-open the pattern and in step S312 change the pattern. Next, in step S314 the user can optionally delete the pattern S314 or append a pattern 316 and then save the pattern again in step S318.

FIG. 14 shows a screen 320 with the pattern for movement of a camera 322. This movement of the camera 322 is set at least initially by the user so that the pattern can be set to reflect random movements of a user as sort of a “shaky cam” to simulate random human movements of a user.

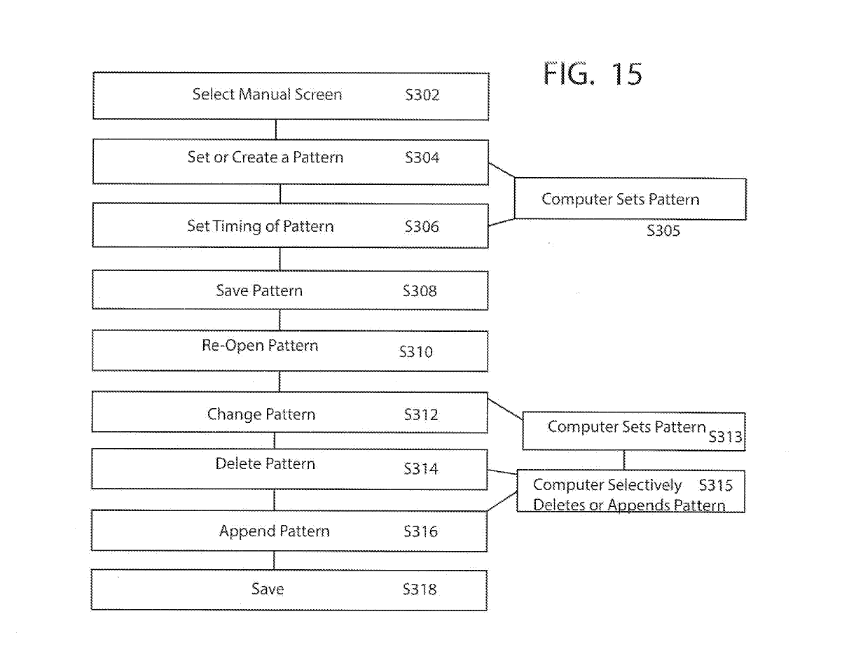

FIG. 15 is a flow chart for the computer augmented process as shown in FIG. 13. For example, with this process, there are a plurality of additional steps which augment the process as shown in FIG. 13. For example, there is step S305 wherein the computer sets the pattern for the “shaky cam” either independent of the user's input or to augment the user's input. This computer control can also influence the timing of the pattern in step S306. If a user wants to change the pattern as well, then the user in step S310 can re-open the pattern to change the existing pattern for the “Shaky cam”. Thus, when the user selects to change the pattern in step S312, the computer can set a pattern in step 313 to change or re-set a pattern. Alternatively, the system can selectively delete or append a new pattern on an existing pattern in step 315 or delete a portion of an existing pattern as well. These computerized steps can be performed by microprocessor 201, operating using a preset set of patterns which can be used to automatically change or alter an existing pattern.

When the camera mounted as fixed on the tripod it can be useful in some situations to have this feature available. The path of the movements can be achieved by applying mathematic or Bezier functions (see step S313), made by hand or reproduced from earlier recorded real movements. It can be useful mostly in devices where is size of the chip larger than the captured area e.g. HD1080 recording on the 4K camera. Then, these movements can be applied virtually to the output and the recorded movie by the processor of the camera. So the result will be moving picture as if I hold it in the hand even when the camera isn't moving. These movements can be even generated using the optical stabilization device, if such device is present in the camera. The optical stabilization device will be in this case used to move the sensor of the camera according to desired path. There can be set settings like duration, in and out duration, amplitude, and pattern.

Movements of the still or motion picture can be achieved by the same methods as described above (mathematic or Bezier functions, made by hand or reproduced from earlier recorded real movements). Such method of the movements of the picture will be applied to a selected or whole part of the movie, as well as it can be applied to a still picture. Then to the video or still picture will be added movements according the chosen path. Then the video or still picture will be not so still but it will look more realistic and have particular feeling. There can be set settings like duration, in and out duration, amplitude, and pattern.

This method can be used even as the built in feature of the photographic and movie cameras.

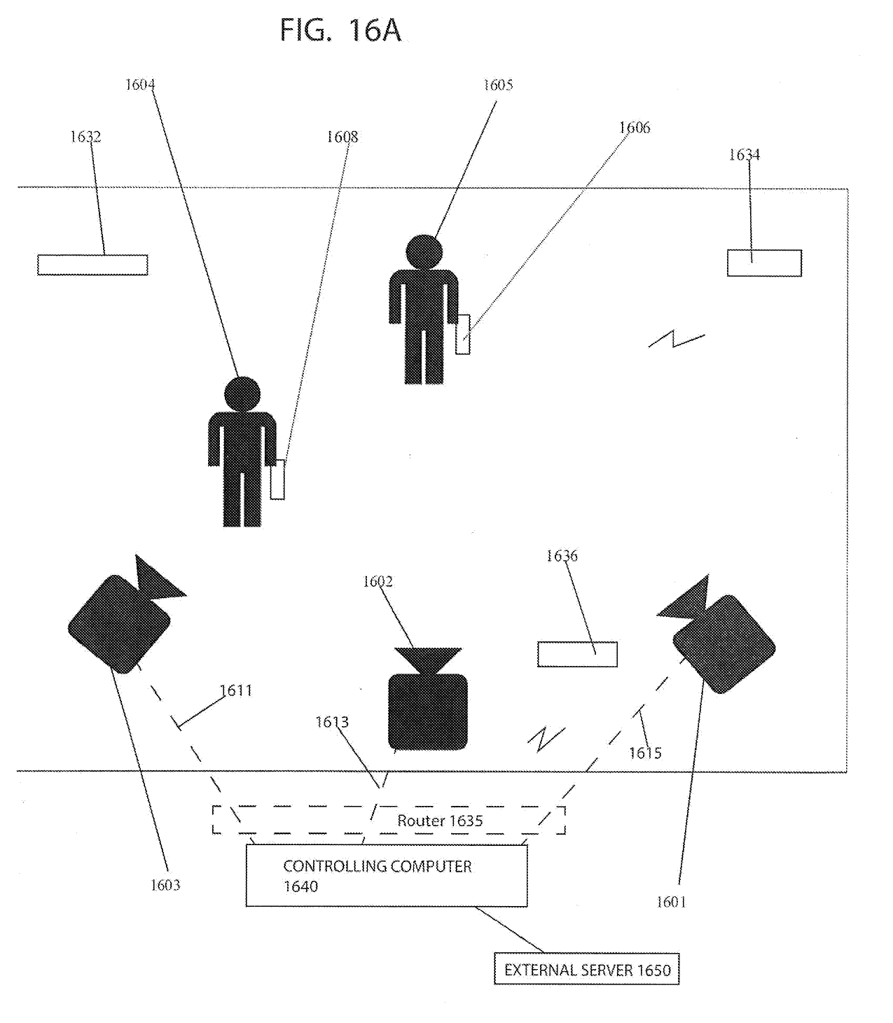

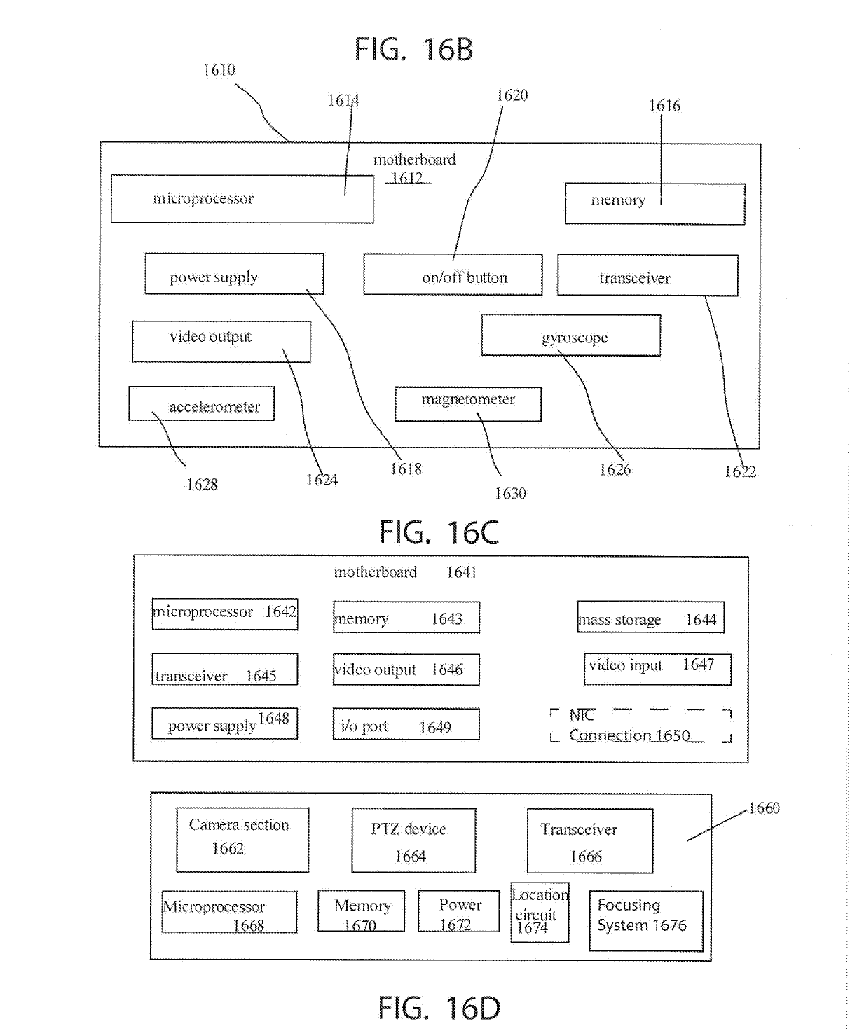

FIG. 16A shows another embodiment which shows three cameras 1601, 1602 and 1603 which are configured to be used to track a particular object or multiple objects such as tracking devices 1606 and 1608. User or subject 1604 has device 1608, and user or subject 1605 has device 1606. The cameras 1601, 1602, and 1603, are configured to follow these devices and to train the focus and directional attention on these devices.

A camera such as camera 1601, 1602, and 1603, in this text can mean photographic or movie camera or smartphone attached on the PT (Pan/Tilt) or PTZ (Pan/Tilt/Zoom) system.

In this embodiment, while the device for tracking individuals can be a smartphone, the smartphone can be replaced by small computer with gyroscoping system and accelerometers eventually magnetometer shown in FIG. 16B. The location finding features of these devices can be used to relay tracking coordinates wherein all of the coordinates confirming the directional pointing can be done by pressing hardware or display button on the smartphone of by the NFC communicator which when placed originally near the camera relays the camera's identity and location.

For example, FIG. 16A shows for example three different cameras, a first camera 1601, a second camera 1602, and a third camera 1603. There are also two different subjects 1604 and 1605. The system is configured to track a subject which is filmed to be every time in the camera shot even when subject is moving. This will be achieved using ordinary smartphones such as smartphone devices 1606 and 1608 with gyroscope systems and accelerometers and eventually magetometer and the particular application disclosed above. The above application can be installed on smartphones or installed on a remote computer and then used to control the cameras remotely or in an integrated manner.

When more than one camera is present this task is possible to do by reaching each camera in it's place by touching one of smartphones and confirming it's position. The touch of at least one button on the smartphone or device can activate the tracking features on the device to cause the cameras to track the device. The tracking is done by tracking the location of the device based upon signals put out by the device such as Wifi signals. When the computer based applications are running, they capture every movement of the device in space and they calculate at each time the absolute position of the device. In this case, the subject such as either subject 1604 or 1605 has also one smartphone in his pocket. The subject being filmed has an optional feature to put the smartphone in front of his face and confirm position of his face. By placing the smartphone in front of the subject's face and then calibrating the location of the user's face, the smartphone can serve to track the user's face when the user is being tracked by other cameras.

This is not necessary but it can improve camera tracking, because subject can hold his smartphone in the jacket or in the pants and the system will know every time the vector from the position of the subject's smartphone to the position of the face. Smartphones will be connected together either direct or in usual cases on the same wifi network or via direct wireless connection. For example, there can be more cameras on the setup and even more subjects which can be tracked. Cameras as well as the subjects can move freely. The operator of this network can then choose which camera will track which subject. This can be achieved by the operator controlling the cameras via the controlling computer 1640.

Next, the system is configured to determine the location of the cameras such as cameras 1601, 1602, and 1603. Next, the system through the focus and optical capabilities of the cameras can locate the users who are operating the devices. When the system knows the exact position of all subjects and cameras the system can exactly to set focus all of the cameras to the desired subjects. The system can choose on one of the controlling devices 1606 or 1608 which camera targets to which subject. It can operate even without PTZ system 1664 (See FIG. 16D) to control only the focus of the cameras.

The system can be configured to communicate via either wirelines such as lines 1611, 1613 and 1615 or wirelessly. This type of wireline communication can be so that the system provides additional power to additional devices such as pan/tilt/zoom (PTZ) devices. Alternatively, the system can be configured for wirelessly controlling the PTZ (Pan Tilt/Zoom) and/or focusing devices.

The control computer 1640 can control any one of these devices in the infrastructure. The control computer can be one of the smartphones, computer or small computing device such as raspberry PI, arduino or similar connected by wire or wireless via any of protocol like bluetooth, wifi, NFC or similar.

The focusing system 1676 (See FIG. 16D) of the camera such as any one of cameras 1601, 1602, and/or 1603 can be controlled via USB, built in features of the operating's system, hardware rotating unit or via the adapter attached on the lens of the camera.

The device 1606 or 1608 is shown by way of example in FIG. 16B. For example there is shown a schematic layout of the device 1610 which is representative of any one of devices 1606 or 1608. Device 1610 includes a motherboard 1612, a microprocessor 1614, a memory 1616, a power supply 1618, an on/off button 1620, a transceiver 1622, a video output 1624, a gyroscope 1626, an accelerometer 1628, and a magnetometer 1630. These components are all in electrical communication with each other via motherboard 1612, and these components are all powered by power supply 1618 through motherboard 1612. In at least one embodiment, power supply 1618 comprises a battery.

FIG. 16C is a schematic block diagram of an example of the controlling computer 1640. Controlling computer 1640 comprises a motherboard 1641, a microprocessor 1642, a memory 1643, a mass storage device 1644 (hard drive), a transceiver 1645, a video output 1646, a video input 1647, a power supply 1648, and an input/output I/O port 1649. The components are coupled together in electrical communication with each other on motherboard 1641 and are each powered by power supply 1648. There is also an optional NIC connection if the device is to be in wired communication with the cameras such as via wires 1611, 1613 and 1615.

FIG. 16D is a schematic block diagram of an example of any one of cameras 1601, 1602, or 1603. For example in each of these cameras 1660 there is a motherboard 1661, a camera unit or section 1662, a PTZ device 1664, a transceiver 1666, a microprocessor 1668, a memory 1670, a power supply 1672, a location circuit 1674, and a focusing system 1676. Each of these elements is coupled to each other on motherboard 1661 and powered by power supply 1672. Power can be either through an individual power supply or fed by power over Ethernet (POE) which is fed from a POE connection to a router 1635 which can be for example a POE router.

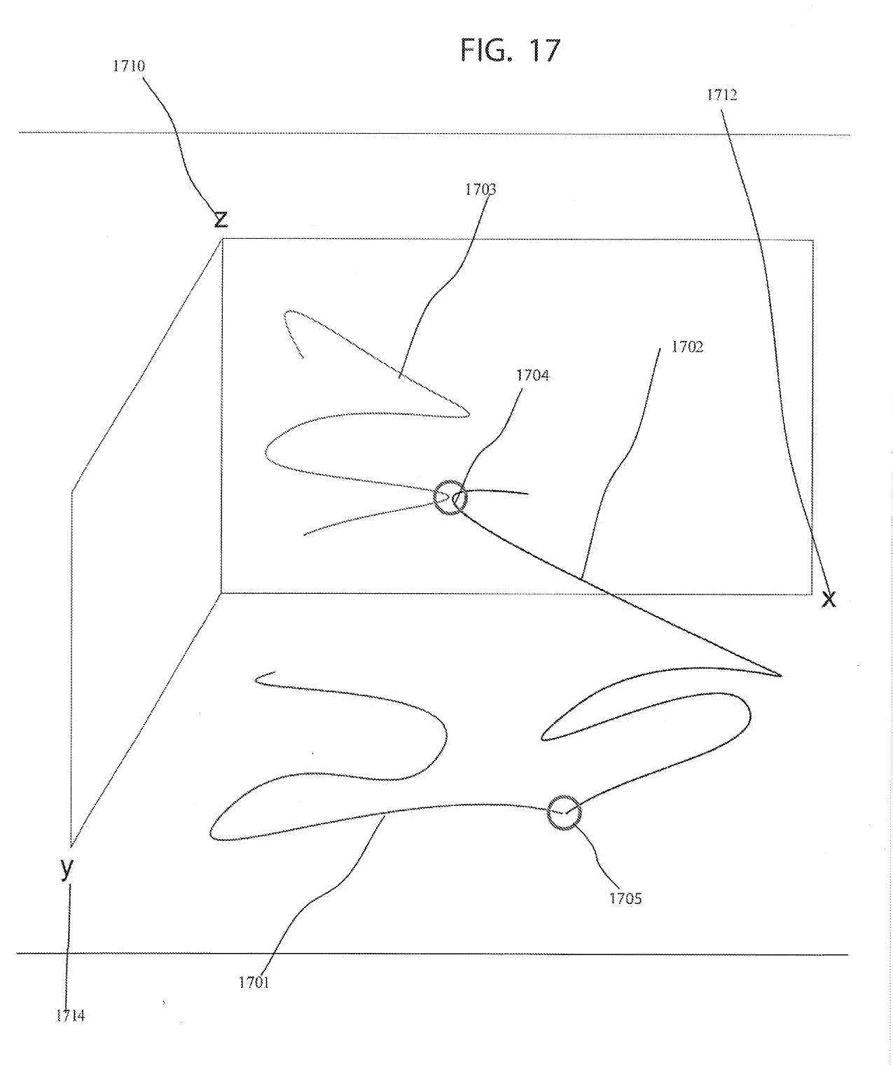

FIG. 17 shows the graphical trajectories 1701, 1702, and 1703 of three devices with the associated gyroscopes accelerometers and possibly magnetometers. The circles 1704 and 1705 represent calibrating points when are trajectories in common point (they are close each on the other). Each device such as any one of cameras 1601, 1602, and 1603 can then calculate the movements in the space and exactly know position of other devices—subjects (cameras, objects or persons).

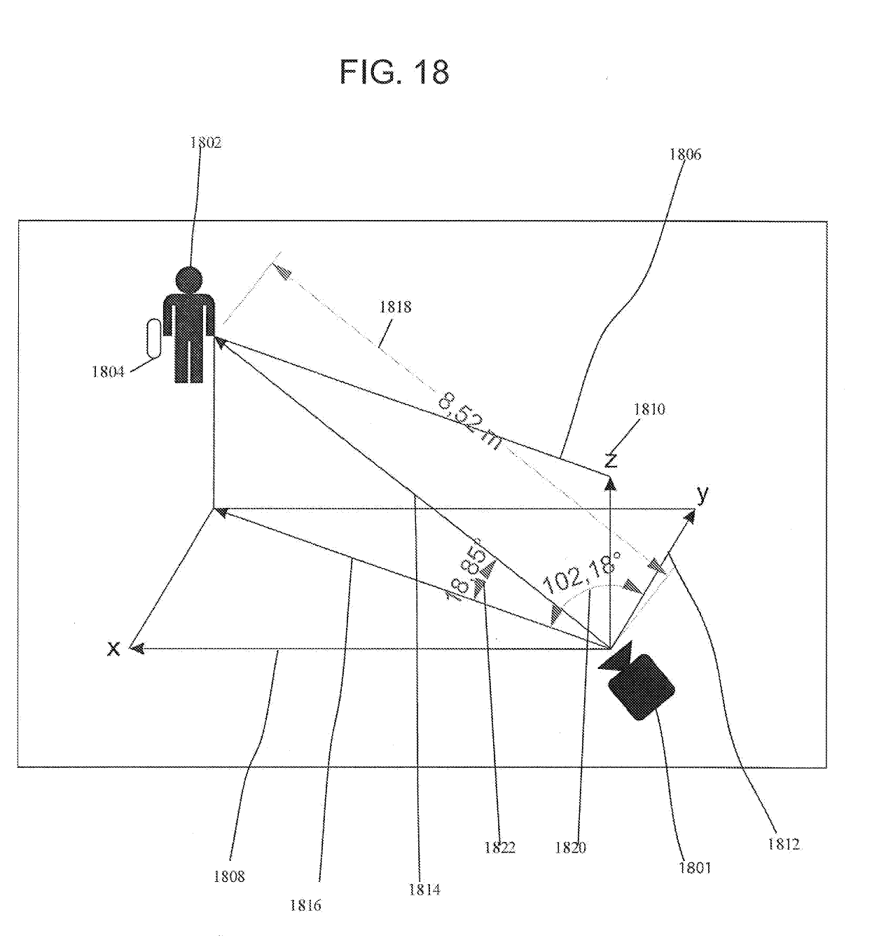

FIG. 18 is an example of a user being tracked using the device shown in FIG. 16B. For example, FIG. 18 shows layout of the camera 1801 pointing at a subject 1802. The subject 1802 is holding/carrying a device 1804 which can be placed on the subject 1802. This diagram shows a plurality of different axes including an x-axis 1808, the y-axis 1812, and is the Z axis 1810. A plurality of different lines 1806, 1814, 1818, and 1816, extend out from the camera 1801. These lines can include a line 1818 which designates the distance from the camera to the subject.

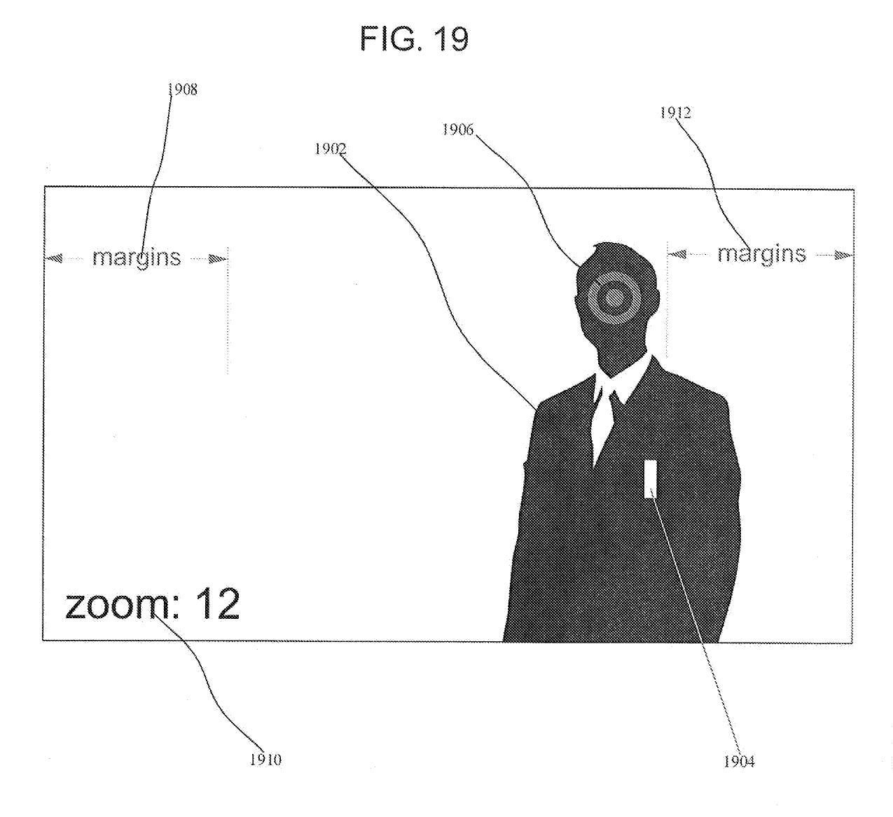

FIG. 19 is an example of a screenshot of a user who is being tracked by a camera wherein the user has a tracking device. With this design, there is a subject which is a person 1902 who has a device 1904. Cameras such as camera 1801, or 1601, 1602, or 1603 targeted in the target 1906. The screen is preset with margins 1908 in 1912. These margins ensure that the target such as target 1906 is positioned in a central location on the screen. In addition, there is a zoom indicator 1910 which indicates the level of zoom on the screen.

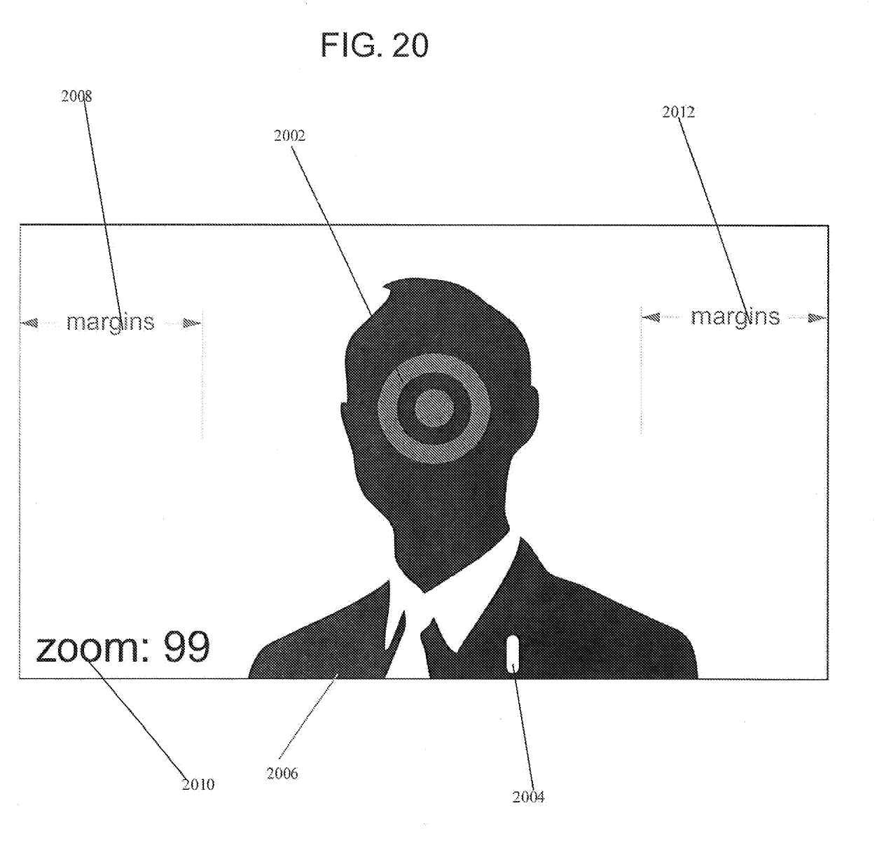

FIG. 20 is an example of a screen shot of a user being tracked. For example, in this view, there is a user 2006 with a device 2004. The target of the user 2002 is the face. The screen is set with margins 2008 and 2012. The screen also indicates a zoom level of 99 as indicated by indicator 2010. In both of these examples shown in FIGS. 19 and 20, the controlling computer 1640 is configured to set the margins for centering the camera on the screen.

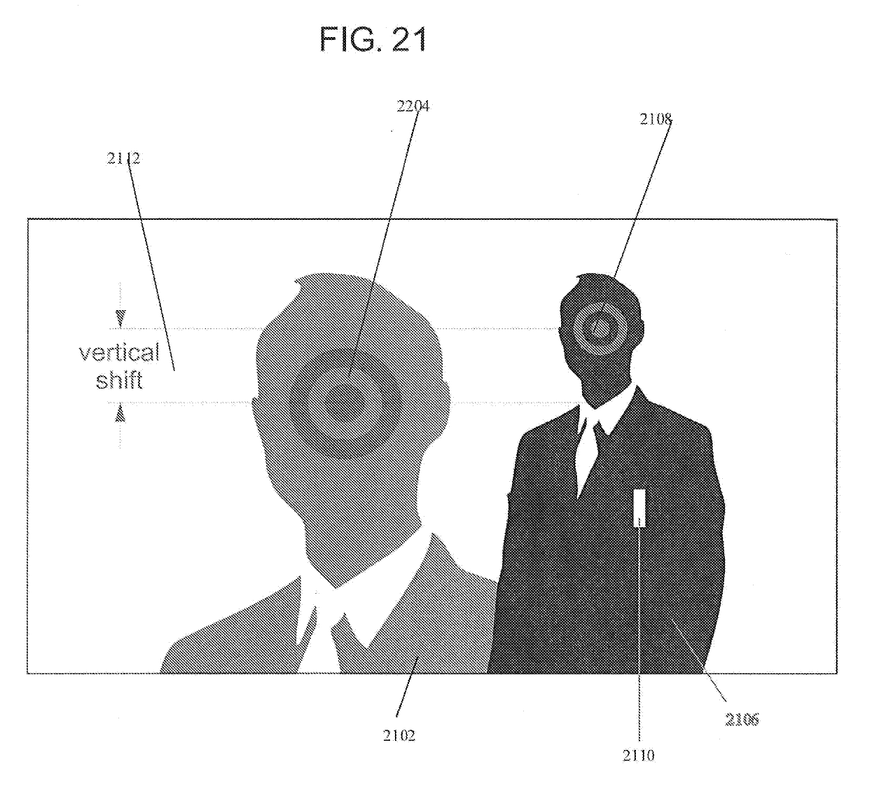

FIG. 21 is an example of a screen shot of a user being tracked. For example, in this view, there is an indication of a vertical shift 2112, which indicates the shifting of the target 2104, for a user 2102. For example, in another view there is a user 2106 who has device 2110 which is used to track the user, particularly the target for the user 2108.

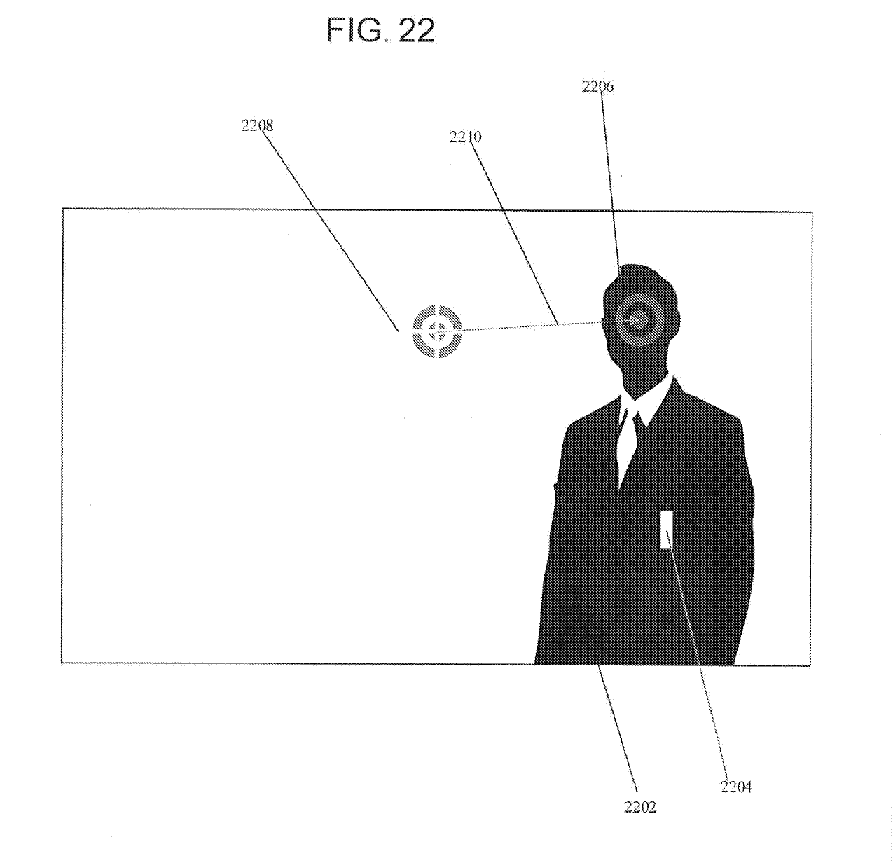

FIG. 22 is an example of a user being tracked. For example, there is shown the user 2202, was being tracked by device 2204. The target 2206 is the users face. However, the target can be translated axially along the line 2210 to a new target position 2208.

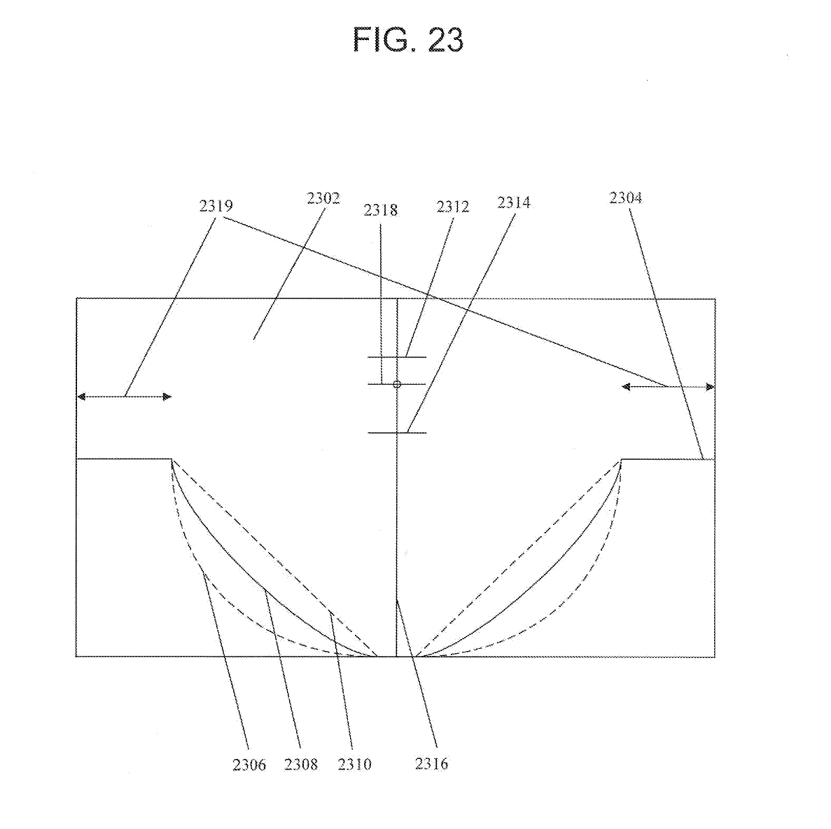

FIG. 23 discloses a screen 2302 along with different shapes of the force 2306, 2308, 2310, wherein the moving object is presented as a center of the screen. When the subject is moving in small ranges around the middle of the screen, the subject is followed by a PTZ device. The more the subject reaches the margins of the screen, the higher the force that is used following the subject. This is an advantage because the user would always be on the screen. Line 2304 represents the maximum force with which the subject is followed and pushed into the middle of the screen 2316. Thus, the highest force is on the edges of the screen.

Points 2312 and 2314 are endpoints of the vertical shift corresponding to the edge positions of the zoom. Between the two positions are the actual value 2318 of the vertical shift according to the actual zoom level. Point 2316 is the mid point of the screen. Curves 2304, 2306, 2308, and 2310 form the curve representing the force with which the subject is followed in the y axis from the vertical shift position 2318. Arrows 2319 represents the margins. The actual vertical shift 2318 depends on the value of the zoom and selected endpoints of the vertical shift 2312, and 2314. Thus, the curve in the y axis is similar to the curve 2310, 2304 in the X axis.

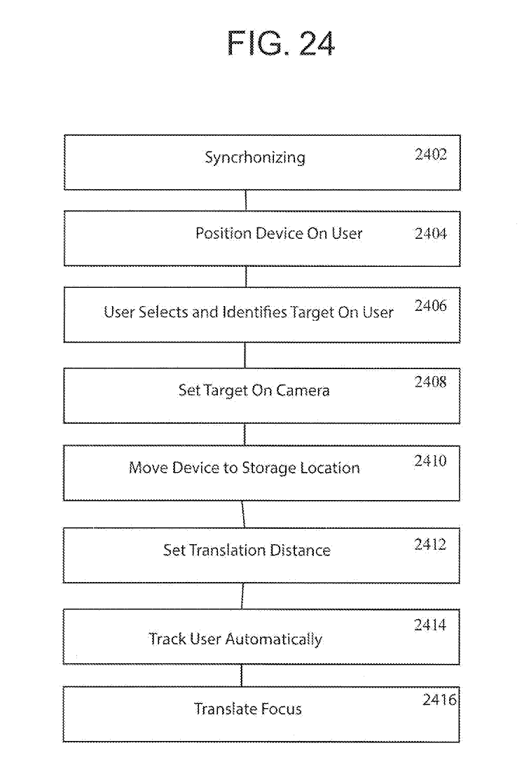

FIG. 24 is the flow chart for the process for tracking subjects such as subjects 1604 and 1605 using cameras 1601, 1602, and 1603 which are coordinated by the system such as microprocessor 201. For example, the process starts with the camera synchronizing with the device in step 2402. Next, in step 2404, the device is positioned on the user. Next, in step 2406 using the device, the user selects and identifies the target location on the user. Next, in step 2408, the user sets the target with the camera. This step can be achieved by having the camera identify the location of the target through recognition software. At this point the user is positioned in the middle of the x-axis of the screen 2316 and the y axis is set to the position of the vertical shift 2318. Next, in step 2410, the user can then move the device to a storage location on the user. This storage location can for example be a pocket in the user's suit. Next, in step 2412, the system, including the camera, and the controlling computer 1640 can set the translation distance or location distance for tracking the target with respect to the storage location of the device. This translation distance allows for the tracking of a translated location of a user such as a user's face.

Next, in step 2414 the system can track the user with the camera automatically, wherein the camera first keys onto the device. Thus, as the subject is moving, and reaching further in position relative to position 2316 of the x-axis or 2318 of the y-axis the subject is followed by the PTZ device with force corresponding to the particular distance according to the force curve 2308, or 2306 and 2310. Thus, the actual curve 2308 is set so that the subject will never reach out of the margins 2319 even when it is moving fast. Next, the system including controlling computer 1640 translates the focus of the camera from the position of the tracking device onto the position of the target in step 2416.

Thus, this system allows for tracking both a device which can be stored on a user as well as tracking a translated location such as a new target with respect to a user. Each movement of the device allows for the coordinated movement of the camera to a new focal position to track the translated position of the user relative to the moving device.

Accordingly, while at least one embodiment of the present invention has been shown and described, it is obvious that many changes and modifications may be made thereunto without departing from the spirit and scope of the invention.

What is claimed is:

1. A display screen comprising:
a first area comprising at least one status indicator;
at least one window having at least one video source;
a cut and transition control section;
a plurality of buttons for switching sources and events;
at least one area for settings of the parameters wherein the display screen is configured to allow control over multiple graphic and video sources to a single screen which allows for the selection of different types of media from different sources.

2. The display screen as in claim 1, wherein said display screen further comprises at least one of the following buttons: help, mute, audio, audio settings, autofocus, snapshot, current time, recording duration, and settings.

3. The display screen as in claim 1, wherein said display screen further comprises preview window positioned top left and/or output window positioned top right.

4. The display as in claim 1, wherein the display comprises a plurality of windows with videos, pictures and graphics from a plurality of different sources.

5. A process for controlling a camera comprising:
determining an orientation of a camera;
determining whether to reorient a camera;
determining an area for movement for reorientation;
selecting a type of reorientation;
obtaining a pattern for reorientation;
reorienting the camera.

6. The process as in claim 5, wherein the step of determining an area of movement of a camera comprises creating an area of movement of a camera by creating a shape for boundaries of movement of a camera.

7. The process as in claim 6, further comprising the step of re-sizing the area of movement for reorientation.

8. The process as in claim 7, wherein at least one type of reorientation comprises manual reorientation.

9. The process as in claim 8, wherein at least one type of reorientation is a pre-set cycle of movement.

10. The process as in claim 5, wherein at least one type of reorientation comprises creating a hybrid pattern of reorientation which comprises modifying an existing pre-set cycle manually to create a new pre-set cycle for reorientation of a camera.

11. The process as in claim 5, further comprising the step of matching a position of PT/PTZ device as well as of focus of a camera on a device.

12. The process as in claim 11, further comprising the step of translating a position of PT/PTZ device as well as of a focus of a camera to a new position in relation to the device.

13. The process as in claim 12, further comprising tracking the translated position of PT/PTZ device as well as of a focus of the camera based upon movement of the device.

14. The process as in claim 13, wherein the step of tracking the translated position comprises moving the of PT/PTZ device as well as of camera lens to a new focal position based upon the movement of the device.

15. The process as in claim 5, further comprising the step of providing a shaky cam effect by adding of the calculated movements to the horizontal and vertical axis of the PT/PTZ device.

16. The process as in claim 5, further comprising the step of providing a tracking cam by puting devices near together to obtain a common position and further comprising the step of refining the accuracy using magnets and by spatial map of the wireless and magnetic fields.

17. The process as in claim 5, further comprising the step of providing a vertical shift by adding movement of the camera to along a vertical axis of the PT/PTZ device depending on the actual focal length of the lens to achieve better composition of the shot

18. The process as in claim 5, further comprising the step so when is function “HOT” active then after tapping on the particular source this source will be immediately redirected to the output and show in the output window.

19. The process as in claim 5, further comprising providing a join lock which causes that after activating of the particular button or area on the screen there will be automatically updated other areas on the screen with additional content attributable to the activated button or area.

20. The process as in claim 19, wherein the step of tracking the translated position comprises moving the camera lens to a new focal position based upon the movement of the device.
